(19) United States
(12) Patent Application Publication
(10) Pub. No.: US 2017/0126439 A1
(43) Pub. Date: May 4, 2017

(54) BASE STATION APPARATUS AND TRANSMISSION METHOD

(71) Applicant: Sharp Kabushiki Kaisha, Sakai City, Osaka (JP)

(72) Inventors: Takashi YOSHIMOTO, Sakai City (JP); Ryota YAMADA, Sakai City (JP); Kazuyuki SHIMEZAWA, Sakai City (JP)

(21) Appl. No.: 15/306,529

(22) PCT Filed: Apr. 7, 2015
(86) PCT No.: PCT/JP2015/060869

§ 371 Date: Oct. 25, 2016

(30) Foreign Application Priority Data
Apr. 28, 2014 (JP) 2014-092347

(51) Int. Cl. H04L 25/02; H04W 72/08; H04B 17/345; H04L 5/00; H04B 7/06

(52) U.S. Cl. CPC H04L 25/0226; H04L 5/0048; H04B 7/0626; H04B 17/345; H04B 7/0697; H04B 7/0639; H04B 7/0632; H04W 72/082; H04W 88/08

(57) ABSTRACT

Provided are a terminal apparatus and a base station apparatus which can realize efficient data transmission in a wireless environment having various interferences. The base station apparatus communicates with the terminal apparatus. The base station apparatus includes a higher layer processing unit that configures at least one channel state information process which is a configuration relating to a report of channel state information and a reception unit that receives the channel state information which is reported based on the channel state information process. Each channel state information process includes information regarding a channel-state-information estimation reference signal, information regarding a channel-state-information estimation interference measurement resource, and information regarding an interference which is considered for calculating the channel state information.

### TECHNICAL FIELD

The present invention relates to a base station apparatus and a transmission method in a communication system.

### BACKGROUND ART

In a communication system such as Wideband Code Division Multiple Access (WCDMA) (registered trademark), Long Term Evolution (LTE), LTE-Advanced (LTE-A), or Worldwide Interoperability for Microwave Access (WiMAX) by Third Generation Partnership Project (3GPP), in order to realize efficient data transmission, a modulation scheme and a coding rate (MCS: Modulation and Coding Scheme), the number of spatial multiplexing (number of layers, rank) are adaptively controlled in accordance with a channel situation between a base station apparatus (base station, transmission station, transmission point, downlink transmission apparatus, uplink reception apparatus, transmit antenna group, transmit antenna port group, component carrier, eNodeB) or a transmission station corresponding to the base station apparatus, and a terminal apparatus (mobile station apparatus, reception station, reception point, uplink transmission apparatus, downlink reception apparatus, mobile terminal, receive antenna group, receive antenna port group, UE: User Equipment). A method for controlling such modulation scheme and coding rate (MCS) and the number of spatial multiplexing is disclosed in NPL 1 and NPL 2.

For example, in a case where MCS, the number of spatial multiplexing, and the like of a downlink transmission signal (for example, physical downlink shared channel (PDSCH)) which is transmitted in a downlink are adaptively controlled in LTE, a terminal apparatus calculates reception quality information (or also referred to as channel state information (CSI)) with reference to a downlink reference signal (DLRS) included in a downlink transmission signal which is transmitted from a base station apparatus. The terminal apparatus performs feedback of the reception quality information to the base station apparatus through a channel (for example, PUCCH) of an uplink. The base station apparatus transmits a downlink transmission signal subjected to MCS or the number of spatial multiplexing which is selected considering the reception quality information and the like. Examples of the reception quality information include a rank indicator RI for designating the appropriate number of spatial multiplexing, a precoding matrix indicator PMI for designating a suitable precoder, a channel quality indicator CQI for designating an appropriate transmission rate, and the like.

### CITATION LIST

### Non Patent Literature

NPL 1: 3rd Generation Partnership Project: Technical Specification Group Radio Access Network: Evolved Universal Terrestrial Radio Access (E-UTRA): Physical layer procedures (Release 11), 2013. 9, 3GPP TS36.213 V11.4.0 (2013-09)

NPL 2: 3rd Generation Partnership Project: Technical Specification Group Radio Access Network: Evolved Universal Terrestrial Radio Access (E-UTRA): Radio Resource Control (RRC): Protocol specification (Release 11), 2013. 9, 3GPP TS36.331 V11.5.0 (2013-09)

NPL 3: 3rd Generation Partnership Project: Technical Specification Group Radio Access Network: Further Advancements for E-UTRA Physical Layer Aspects (Release 9), 3GPP TR36.814 v9.0.0 (2010-03) URL: http://www.3gpp.org/ftp/Specs/html-info/36814.htm

### SUMMARY OF INVENTION

### Technical Problem

In the communication system, a cellular configuration is provided in which a plurality of areas that are covered by a base station apparatus or a transmission station corresponding to the base station apparatus and each have a cell shape are disposed, and thus it is possible to expand a communication area. In the cellular configuration, if the same frequency is used between the adjacent cells or between sectors, it is possible to improve spectral efficiency. In the cellular configuration, in order to further improve the spectral efficiency, diversification of a cell constitution (for example, heterogeneous network or the like) has been proposed in which cells having a different cell radius overlap each other (NPL 3).

In the communication system, in order to realize efficient data transmission, spatial multiplexing transmission (MIMO: Multi Input Multi Output) is applied. In order to improve spectral efficiency, an increase of the number of spatial multiplexing or spatial multiplexing transmission (MU-MIMO: Multi User-MIMO) performed by a plurality of users is applied (NPL 1).

However, in such a cellular configuration, a terminal apparatus positioned in a cell edge region or a sector edge region receives interference (inter-cell interference, inter-sector interference) by a transmission signal of a base station apparatus which constitutes another cell or another sector. The number of spatial multiplexing is increased, and thus inter-stream interference (inter-layer interference, inter-antenna interference) is increased. Thus, in a case where a terminal apparatus calculates reception quality information based on the downlink reference signal (DLRS), and performs feedback of the calculated reception quality information to a base station apparatus, transmission of a downlink transmission signal with the optimal MCS, the optimal number of spatial multiplexing, or the like by the base station apparatus is not possible in a wireless environment having various interferences, in some cases. As a result, sufficient improvement in the spectral efficiency of the communication system is not possible.

Considering the above problem, an object of the present invention is to provide a terminal apparatus, a base station apparatus, a communication system, a transmission method, a reception method, and a communication method which can realize efficient data transmission in a wireless environment having various interferences.

### Solution to Problem

To solve the above-described problem, a configuration of a base station apparatus and a transmission method according to the present invention is as follows.

(1) A base station apparatus according to an aspect of the present invention communicates with a terminal apparatus. The base station apparatus includes a higher layer processing unit that configures at least one channel state information process which is a configuration relating to a report of channel state information, and a reception unit that receives the channel state information which is reported based on the channel state information process. Each channel state information process includes information regarding a channel-state-information estimation reference signal, information regarding a channel-state-information estimation interference measurement resource, and information regarding an interference which is considered for calculating the channel state information.

(2) In the base station apparatus according to the aspect of the present invention, the higher layer processing unit configures a transmission mode of a downlink, which corresponds to information indicating a transmission method for transmitting user data of a downlink. In a case where the transmission mode is a predetermined transmission mode, the higher layer processing unit configures information regarding an interference which is considered for calculating the channel state information.

(3) In the base station apparatus according to the aspect of the present invention, the transmission mode of a downlink includes at least a transmission mode in which the information regarding the channel-state-information estimation reference signal and the information regarding the channel-state-information estimation interference measurement resource are allowed to be configured. In a case where the higher layer processing unit configures the transmission mode in which the information regarding the channel-state-information estimation interference measurement resource is allowed to be configured, the higher layer processing unit configures the information regarding an interference which is considered for calculating the channel state information.

(4) In the base station apparatus according to the aspect of the present invention, the higher layer processing unit configures information regarding a feedback procedure of the channel state information. In a case where the information regarding a feedback procedure of the reception state information corresponds to a predetermined mode, the higher layer processing unit configures the information regarding an interference which is considered for calculating the channel state information.

(5) In the base station apparatus according to the aspect of the present invention, the higher layer processing unit configures information regarding a type of feedback of the reception state information. In a case where the information regarding a feedback type of the reception state information corresponds to a predetermined mode, the higher layer processing unit configures the information regarding an interference which is considered for calculating the channel state information.

(6) In the base station apparatus according to the aspect of the present invention, the report of the reception state information includes a rank indicator for designating an appropriate number of spatial multiplexing, a precoding matrix indicator for designating a suitable precoder, and a channel quality indicator CQI for designating an appropriate transmission rate. In a case where the higher layer processing unit configures the rank indicator, the higher layer processing unit configures the information regarding an interference which is considered for calculating the channel state information.

(7) In the base station apparatus according to the aspect of the present invention, the information regarding an interference which is considered for calculating the channel state information includes a cell identifier of a cell to which a terminal apparatus other than the terminal apparatus is connected.

(8) In the base station apparatus according to the aspect of the present invention, the information regarding an interference which is considered for calculating the channel state information includes transmission power which is transmitted by a terminal apparatus other than the terminal apparatus.

(9) In the base station apparatus according to the aspect of the present invention, the information regarding an interference which is considered for calculating the channel state information includes information for specifying a resource to which a reference signal for reception state information of a terminal apparatus other than the terminal apparatus is assigned.

(10) A transmission method of the base station apparatus according to an aspect of the present invention is a transmission method of a base station apparatus which communicates with a terminal apparatus. The transmission method includes a step of configuring at least one channel state information process which is a configuration relating to a report of channel state information, and a step of receiving the channel state information which is reported based on the channel state information process. Each channel state information process includes information regarding a channel-state-information estimation reference signal, information regarding a channel-state-information estimation interference measurement resource, and information regarding an interference which is considered for calculating the channel state information.

### Advantageous Effects of Invention

According to the present invention, it is possible to realize efficient data transmission in a wireless environment having various interferences.

### BRIEF DESCRIPTION OF DRAWINGS

FIG. 1 is a schematic diagram illustrating a structure of a communication system according to an embodiment.

FIG. 2 is a diagram illustrating a schematic structure of a radio frame in the embodiment.

FIG. 3 is a diagram illustrating an example of calculating a narrow-band CSI in the embodiment.

FIG. 4 is a diagram illustrating another example of calculating a narrow-band CSI in the embodiment.

FIG. 5 is a diagram illustrating an example of mapping a physical channel and a physical signal in a downlink subframe, in the embodiment.

FIG. 6 is a diagram illustrating another example of mapping a physical channel and a physical signal in a downlink subframe, in the embodiment.

FIG. 7 is a diagram illustrating a sequence in a case where channel state information is aperiodically reported, in the embodiment.

FIG. 8 is a diagram illustrating an example of mapping a physical channel and a physical signal in a downlink physical resource block of a base station apparatus 100-1 according to the embodiment.

FIG. 9 is a diagram illustrating an example of mapping a physical channel and a physical signal in a downlink physical resource block of a base station apparatus 100-2 according to the embodiment.

FIG. 10 is a schematic block diagram illustrating a structure of a base station apparatus according to the embodiment.

FIG. 11 is a schematic block diagram illustrating a structure of a terminal apparatus according to the embodiment.

### DESCRIPTION OF EMBODIMENTS

Hereinafter, an embodiment according to the present invention will be described with reference to the drawings.

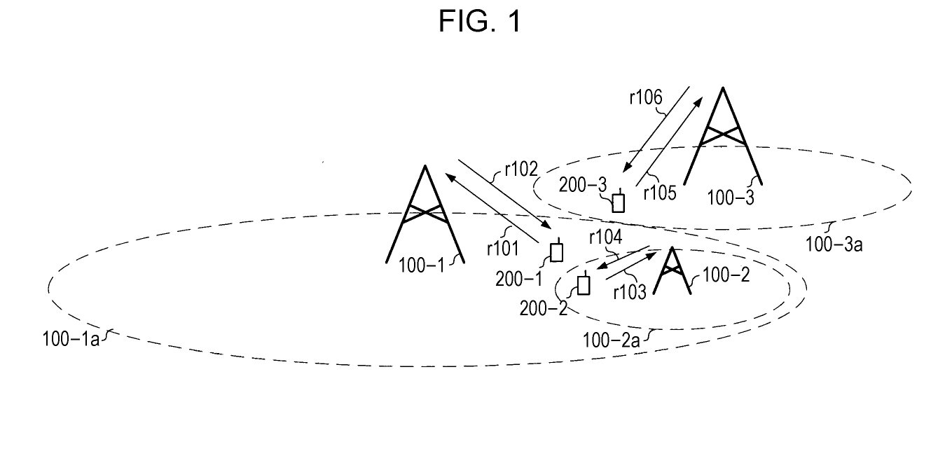

FIG. 1 is a schematic diagram illustrating a structure of a communication system according to an embodiment. A communication system in FIG. 1 is an example which is configured by base station apparatuses 100-1, 100-2, and 100-3 (base station, transmission station, transmission point, downlink transmission apparatus, uplink reception apparatus, transmit antenna group, transmit antenna port group, component carrier, eNodeB), and terminal apparatuses 200-1, 200-2, and 200-3 (mobile station apparatus, reception station, reception point, uplink transmission apparatus, downlink reception apparatus, mobile terminal, receive antenna group, receive antenna port group, UE: User Equipment). The terminal apparatus 200-1 is connected to the base station apparatus 100-1 which has a connectable range (cell, component carrier) 100-1a. The terminal apparatus 200-2 is connected to the base station apparatus 100-2 which has a connectable range (cell) 100-2a. The terminal apparatus 200-3 is connected to the base station apparatus 100-3 which has a connectable range (cell, component carrier) 100-3a. In FIG. 1, the cells 100-2a and 100-3a have a connectable range narrower than that of the cell 100-1a. However, the communication system described in the embodiment can be also applied between cells which have substantially the same size. In FIG. 1, the cell 100-1a encloses the cell 100-2a. However, the communication system described in the embodiment can be also applied between cells which are adjacent to each other.

In the embodiment, “X/Y” includes the meaning of “X or Y”. In the embodiment, “X/Y” includes the meaning of “X and Y”. In the embodiment, “X/Y” includes the meaning of “X and/or Y”.

In FIG. 1, the base station apparatuses 100-1 transmits and receives uplink data (for example, UL-SCH: Uplink-Shared Channel), downlink data (for example, DL-SCH: Downlink-Shared Channel), uplink control information (for example, UCI: Uplink Control Information), downlink control information (for example, DCI: Downlink Control Information, and the like), a reference signal (UL-RS: Uplink-Reference Signal, DL-RS: Downlink-Reference Signal, and the like) by using an uplink signal r101 and a downlink signal r102. The base station apparatuses 100-2 transmits and receives the above-described data and signal by using uplink signal r103 and a downlink signal r104. The base station apparatuses 100-3 transmits and receives the above-described data and signal by using uplink signal r105 and a downlink signal r106 (the signal will be described later in detail).

In FIG. 1, the terminal apparatuses 200-1, 200-2, and 200-3 can configures an advanced reception function (advanced signal detection function, NAICS: Network Assisted Interference Cancellation and Suppression, advanced SU-MIMO detection: Single User-Multiple Input Multiple Output detection). As the advanced reception function, linear detection, maximum likelihood estimation, an interference canceller, and the like are provided. Examples of the linear detection include Enhanced linear minimum mean square error-interference rejection combining (LMMSE-IRC) and widely linear MMSE-IRC (WLMMSE-IRC). Examples of the maximum likelihood estimation include maximum likelihood (ML), reduced complexity ML (R-ML), Iterative ML, and iterative R-ML. Examples of the interference canceller include turbo successive interference cancellation (SIC), parallel interference cancellation (PIC), linear code word level SIC (L-CWIC), ML code word level SIC (ML-CWIC), and symbol level IC (SLIC). The advanced reception function in the NAICS corresponds to the linear detection, the maximum likelihood estimation, the interference canceller, and the like. The advanced reception function in the SU-MIMO detection corresponds to the maximum likelihood estimation and the interference canceller.

The terminal apparatuses 200-1, 200-2, and 200-3 can perform a configuration which does not have the advanced reception function. For example, if comparison to a terminal apparatus having the advanced reception function in the NAICS is performed, the terminal apparatus which does not have the advanced reception function corresponds to a terminal apparatus which includes linear reception such as MMSE detection and LMMSE-IRC detection. For example, if comparison to a terminal apparatus having the advanced reception function in the SU-MIMO detection is performed, the terminal apparatus which does not have the advanced reception function corresponds to a terminal apparatus which includes MMSE detection.

In FIG. 1, the terminal apparatus 200-1 causes the downlink signals r104 and r106 to function as inter-cell interference (may be also referred to as inter-sector interference). The terminal apparatus 200-2 causes the downlink signal r102 to function as inter-cell interference. The terminal apparatuses 200-1, 200-2, and 200-3 can remove or suppress the inter-cell interference by using the advanced reception function. In FIG. 1, the base station apparatuses 100-1, 100-2, and 100-3 can perform spatial multiplexing transmission of the downlink signals r102, r104, and r106. In this case, each of the terminal apparatuses receives inter-stream interference (inter-layer interference, inter-antenna interference). The terminal apparatuses 200-1, 200-2, and 200-3 can remove or suppress the inter-stream interference by using the advanced reception function.

In FIG. 1, the base station apparatuses 100-1, 100-2, and 100-3 respectively transmit the downlink signals r101, r103, and r105 in accordance with a predetermined structure of a radio frame. The terminal apparatuses 200-1, 200-2, and 200-3 respectively transmit the uplink signals r102, r104, and r106 in accordance with a predetermined structure of a radio frame.

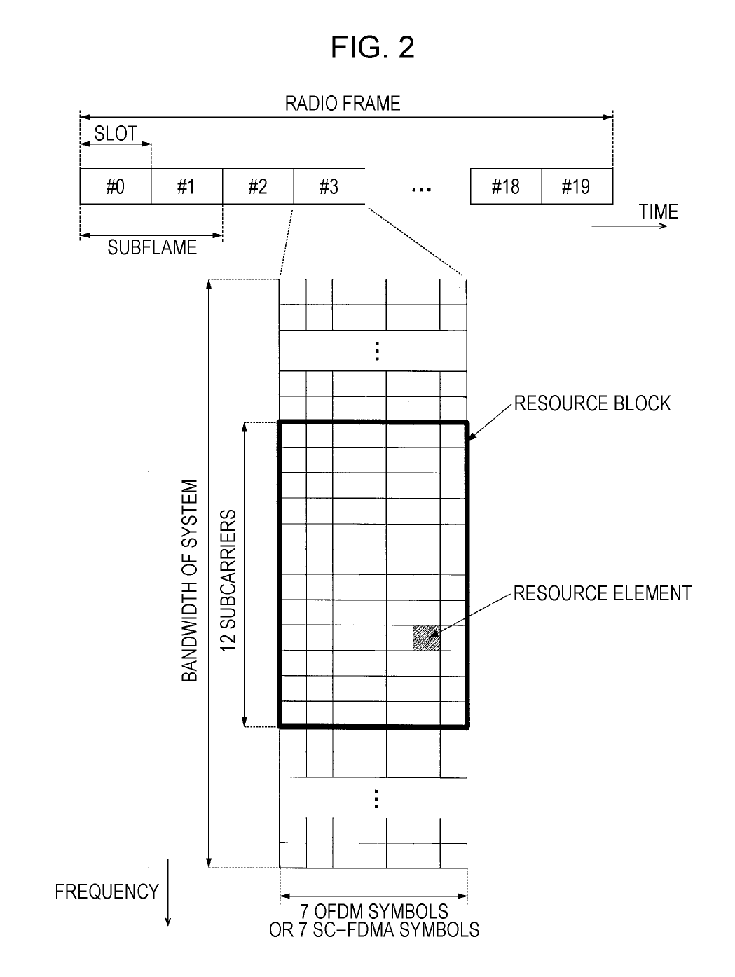

FIG. 2 is a diagram illustrating a schematic structure of a radio frame in the embodiment. In FIG. 2, a horizontal axis indicates a time axis. For example, in frequency division duplex (FDD), the base station apparatuses 100-1, 100-2, and 100-3, and the terminal apparatuses 200-1, 200-2, and 200-3 respectively transmits the signals r101 to r106 in accordance with a radio frame in FIG. 2. For example, the length of each radio frame is Tf=307200·Ts=10 ms. Tf is referred to as radio frame duration. Is is referred to as a basic time unit.

The radio frame is constituted by two half frames. The length of each of the half frames is 153600·Ts=5 ms. Each of the half frames is constituted by five subframes. The length of each of the subframes is 30720·Ts=1 ms.

Each of the subframes is defined by two consecutive slots. The length of each of the slots is Tslot=15360·Ts=0.5 ms. An i-th subframe in a radio frame is constituted by a (2×i)th slot and a (2×i+1)th slot. That is, 10 subframes can be used at each internal of 10 ms. Here, the subframe is also referred to as a transmission time interval (TTI). FIG. 2 illustrates an example in which frequency division duplex is applied. However, time division duplex (TDD) can be also applied.

A physical signal or a physical channel transmitted in each slot is expressed by resource grid. The resource grid in a downlink is defined by a plurality of subcarriers and a plurality of OFDM symbols. The resource grid in an uplink is defined by a plurality of subcarriers and a plurality of SC-FDMA symbols.

The number of subcarriers constituting one slot depends on a system bandwidth (bandwidth of a cell). For example, the number of OFDM symbols or SC-FDMA symbols constituting one slot is 7. Each element in the resource grid is referred to as a resource element. The resource element is identified by using a subcarrier number, and an OFDM symbol number or a SC-FDMA symbol number.

A resource block is used for expressing mapping to a resource element of a certain physical channel (PDSCH, PUSCH, or the like). In the resource block, a virtual resource block and a physical resource block are defined. A certain physical channel is firstly mapped to the virtual resource block. Then, the virtual resource block is mapped to the physical resource block.

For example, one physical resource block is defined by seven continuous OFDM symbols or SC-FDMA symbols in a time domain, and twelve continuous subcarriers in a frequency domain. Thus, one physical resource block is constituted by (7×12) resource elements. One physical resource block corresponds to one slot in the time domain, and corresponds to 180 kHz in the frequency domain. The physical resource block is numbered from 0 in the frequency domain.

In FIG. 1, a downlink physical channel is used in a radio communication using the downlink signals r101, r103, and r105 from the base station apparatuses 100-1, 100-2, and 100-3 to the terminal apparatuses 200-1, 200-2, and 200-3. The downlink physical channel can be used for transmitting information which has been output from a higher layer. The downlink physical channel includes a physical broadcast channel (PBCH), a physical control format indicator channel (PCFICH), a physical hybrid automatic repeat request indicator channel (PHICH), a physical downlink control channel (PDCCH), an enhanced physical downlink control channel (EPDCCH), a physical downlink shared channel (PDSCH), a physical multicast channel (PMCH), and the like.

The PBCH is used for broadcasting a master information block (MIB, BCH: Broadcast Channel) in each cell. The master information block is commonly used between terminal apparatuses which are connected to a base station apparatus. The MIB is system information. For example, the MIB includes information (SFN: system frame number) indicating the number of a radio frame, and basic information such as a system bandwidth and the number of transmit antennae.

The PCFICH is used for transmitting information which is used for performing an instruction of a region (OFDM symbol) used in transmission of a PDCCH.

The PHICH is used for transmitting a HARQ indicator (HARQ feedback, response information) which indicates acknowledgement (ACK)/negative-acknowledgement (NACK) in response to uplink data (for example, PUSCH: Physical Uplink Shared Channel, details will be described later) received by the base station apparatuses 100-1, 100-2, and 100-3.

The PDCCH and the EPDCCH are used for transmitting downlink control information (DCI). A plurality of DCI formats is defined for transmitting the downlink control information. A field for the downlink control information is defined in a DCI format, and is mapped onto an information bit. The downlink control information may be also referred to as the DCI format.

The base station apparatus can explicitly or implicitly report information regarding application of the advanced reception function. For example, the DCI format can include a field used when the terminal apparatus transmits the information regarding application of the advanced reception function. Regarding the DCI format, a specific DCI format is used among a plurality of DCI formats, and thus the terminal apparatus can report the information regarding application of the advanced reception function.

For example, a plurality of DCI formats such as a DCI format 1A, a DCI format 1B, a DCI format 1D, a DCI format 1, a DCI format 2A, a DCI format 2B, a DCI format 2C, and a DCI format 2D is defined as a DCI format for a downlink. The plurality of DCI formats is defined by the type (field) of control information which is necessary as DCI for a downlink, information quantity (number of bits) of the necessary control information, and the like.

For example, the DCI format for a downlink includes information regarding scheduling of a PDSCH. The DCI format for a downlink is also referred to as a downlink grant (or downlink assignment). For example, the DCI format for a downlink includes downlink control information such as information regarding resource block allocation, information regarding a modulation and coding scheme (MCS), information regarding the number of spatial multiplexing (number of layers), information regarding a TPC command for a PUCCH, and a downlink assignment index (DAI).

For example, in a case where the terminal apparatus receives the information regarding application of the advanced reception function, in downlink control information (DCI) for a downlink, the terminal apparatus detects a PDSCH scheduled in the DCI, as a signal by using the advanced reception function.

In another example, in a case where a terminal apparatus receives the information regarding application of the advanced reception, in downlink control information, the terminal apparatus detects a PDSCH scheduled in the DCI, as a signal by using the advanced reception function, until the terminal apparatus receives the information regarding application of the advanced reception, in the subsequent downlink control information. The information regarding whether the terminal apparatus applies the advanced reception may indicate whether or not the advanced reception function is applied, with “0” and “1”. It may be indicated whether or not the advanced reception function is applied, by using the presence or absence of the information regarding application of the advanced reception, in downlink control information.

The downlink control information can include information regarding an interference signal for a downlink physical channel to which a radio resource is assigned. For example, the information regarding an interference signal is information regarding an interference signal used when a scheduled PDSCH is detected. The information regarding an interference signal is information necessary for demodulating an interference signal, such as a modulation scheme, information regarding a modulation and coding scheme (MCS), information regarding the number of spatial multiplexing (number of layers), and information regarding an antenna port.

The DCI format includes a DCI format for an uplink. For example, the DCI format 0 or the DCI format 4 which is used for scheduling one PUSCH (transmitting one uplink transport block) in one cell is defined.

For example, the DCI format for an uplink includes information regarding scheduling of a PUSCH. For example, the DCI format for an uplink includes downlink control information such as information regarding resource block allocation, information regarding an MCS, and information regarding a TPC command for a PUSCH. Here, the DCI format for an uplink is also referred to as an uplink grant (or uplink assignment).

The DCI format for an uplink can be used for requiring (CSI request) channel state information (CSI, also referred to as reception quality information) of a downlink. Examples of the channel state information include a rank indicator RI for designating the appropriate number of spatial multiplexing, a precoding matrix indicator PMI for designating a suitable precoder, and a channel quality indicator CQI for designating an appropriate transmission rate (details will be described later).

The DCI format for an uplink can be used for indicating information (interference information) regarding an interference which is considered when the terminal apparatus calculates CSI. For example, the interference information corresponds to information relating to a terminal apparatus other than the terminal apparatus. For example, the interference information is information necessary for demodulating an interference signal, such as a cell ID (virtual cell ID) of the interference signal, information regarding an antenna port, a modulation scheme, information regarding a modulation and coding scheme (MCS), information regarding the number of spatial multiplexing (number of layers), and information regarding transmission power. The interference information can include information for specifying a resource to which a CSI-RS is assigned, in an interference signal. The information regarding an interference which is considered for calculating CSI can be assumed to have details different from information regarding an interference signal for a downlink physical channel to which the radio resource is assigned.

In the embodiment, as a reference signal in an interference signal, a CSI-RS, a CRS and/or DMRS, and the like are provided. The interference information includes a portion or the entirety of information for specifying the reference signal in the interference signal. In a case where interference information includes a portion of information for specifying a reference signal in an interference signal, the terminal apparatus can attempt to sequentially detect a plurality of candidates for the reference signal, and thus can specify the reference signal.

The DCI format for an uplink includes information for designating an interference signal in CSI which is calculated considering the interference signal. For example, in a case where information regarding an interference which is considered for calculating the CSI relates to a plurality of interferences (in a case where a plurality of candidates for an interference signal to be considered for calculating CSI is provided), information (for example, Index of an interference signal to be considered) indicating an interference signal to be considered when CSI is calculated, among the plurality of interference signals is included.

The DCI format for an uplink can be used for a configuration indicating an uplink resource which is mapped on channel state information report (CSI feedback report) subjected to feedback to the base station apparatus by the terminal apparatus. For example, the channel state information report can be used for a configuration indicating an uplink resource which is used for periodically reporting channel state information (Periodic CSI). The channel state information report can be used for a mode configuration (CSI report mode) in which channel state information is reported periodically.

For example, the channel state information report can be used for a configuration indicating an uplink resource which is used for reporting aperiodic channel state information (Aperiodic CSI). The channel state information report is used for a mode configuration (CSI report mode) in which channel state information is aperiodically reported. The base station apparatuses 100-1, 100-2, and 100-3 can configure either of the periodic channel state information report and the aperiodic channel state information report. The base station apparatuses 100-1, 100-2, and 100-3 can configure both of the periodic channel state information report and the aperiodic channel state information report.

The DCI format for an uplink can be used for a configuration indicating the type of channel state information report subjected to feedback to the base station apparatus by the terminal apparatus. As the type of the channel state information report, a wide-band CSI (for example, Wideband CQI), a narrow-band CSI (for example, Subband CQI), and the like are provided.

The DCI format for an uplink can be used for a mode configuration which includes the periodic channel state information report or the aperiodic channel state information report, and the type of the channel state information report. For example, a mode in which the aperiodic channel state information report is performed, and a wide-band CSI is reported, a mode in which the aperiodic channel state information report is performed, and a narrow-band CSI is reported, a mode in which the aperiodic channel state information report is performed, and a wide-band CSI and a narrow-band CSI are reported, a mode in which the periodic channel state information report is performed, and a wide-band CSI is reported, a mode in which periodic channel state information report is performed, and a narrow-band CSI is reported, a mode in which the periodic channel state information report is performed, and a wide-band CSI and a narrow-band CSI are reported, and the like are provided.

In a case where a resource of a PDSCH using downlink assignment is scheduled, the terminal apparatuses 200-1, 200-2, and 200-3 receive downlink data on the scheduled PDSCH. In a case where a resource of a PUSCH PDSCH using an uplink grant is scheduled, the terminal apparatuses 200-1, 200-2, and 200-3 transmit uplink data and/or uplink control information on the scheduled PUSCH.

The terminal apparatuses 200-1, 200-2, and 200-3 monitor a set of PDCCH candidates and/or EPDCCH candidates. In the following descriptions, a PDCCH may mean a PDCCH and/or an EPDDCH. The PDCCH candidates mean candidates having a probability of mapping and transmitting a PDCCH by the base station apparatuses 100-1, 100-2, and 100-3. The monitoring may include the meaning in that the terminal apparatuses 200-1, 200-2, and 200-3 attempts to decode each PDCCH in a set of PDCCH candidates in accordance with all monitored DCI formats.

The set of PDCCH candidates monitored by the terminal apparatuses 200-1, 200-2, and 200-3 is also referred to as a search space. The search space includes a common search space (CSS) and a UE-specific search space (USS). The CSS is a space in which a plurality of terminal apparatuses which are connected to a base station apparatus commonly monitors a PDCCH and/or an EPDCCH in a certain cell constituted by the base station apparatus. The terminal apparatuses 200-1, 200-2, and 200-3 monitor PDCCHs and detect a PDCCH for the apparatus itself, in a CSS and/or an USS.

RNTIs which are respectively assigned to the terminal apparatuses 200-1, 200-2, and 200-3 by the base station apparatuses 100-1, 100-2, and 100-3 are used in transmission of downlink control information (transmission on a PDCCH). Specifically, a cyclic redundancy check (CRC) parity bit is added to the downlink control information. After addition, the CRC parity bit is scrambled by an RNTI. Here, the CRC parity bit added to the downlink control information may be obtained from payload of the downlink control information.

The terminal apparatuses 200-1, 200-2, and 200-3 attempt to decode the downlink control information to which a CRC parity bit scrambled by an RNTI is added, and detect downlink control information of which CRC is determined to succeed, as downlink control information for the apparatus itself (also referred to as blind decoding). That is, the terminal apparatuses 200-1, 200-2, and 200-3 detect a PDCCH having attached CRC which is scrambled by an RNTI. The terminal apparatus 1 detects a PDCCH having a DCI format to which a CRC parity bit scrambled by an RNTI is added.

The PDSCH is used for transmitting downlink data. Transmission of downlink data on a PDSCH is also described as transmission on a PDSCH. Reception of downlink data on a PDSCH is also described as reception on a PDSCH.

The PDSCH is used for transmitting a system information block type 1 message. The system information block type 1 message is cell-specific information. The system information block type 1 message corresponds to an RRC message (common RRC message, RRC message common for terminals).

The PDSCH is used for transmitting a system information message. The system information message may include a system information block X other than a system information block type 1. The system information message is cell-specific information. The system information message corresponds to an RRC message.

The PDSCH is used for transmitting an RRC message. An RRC message transmitted from each of the base station apparatuses 100-1, 100-2, and 100-3 may be common between a plurality of terminal apparatuses 1 in a cell. An RRC message transmitted from the base station apparatus 100-1 may be a message (also referred to as dedicated signaling) dedicated for the terminal apparatus 200-1. Similarly, RRC messages transmitted from the base station apparatuses 100-2 and 100-3 may be messages dedicated for the terminal apparatuses 200-2 and 200-3. That is, UE-specific information is transmitted by using a message dedicated for a certain terminal apparatus. The PDSCH is used for transmitting an MAC control element (CE). Here, the RRC message and/or the MAC CE are also referred to as signals of a higher layer (higher layer signaling).

The PDSCH can be used when a terminal apparatus reports information regarding application of the advanced reception function. For example, the RRC message can include information regarding whether a terminal apparatus applies the advanced reception.

For example, in a case where a terminal apparatus receives the information regarding application of the advanced reception function, by using a PDSCH, the terminal apparatus detects a scheduled PDSCH as a signal by using the advanced reception function, until the terminal apparatus receives the information regarding application of the advanced reception, on the subsequent PDSCH. The information regarding whether the terminal apparatus applies the advanced reception may indicate whether or not the advanced reception function is applied, with “0” and “1”. It may be indicated whether or not the advanced reception function is applied, by using the presence or absence of the information regarding whether the terminal apparatus applies the advanced reception, in the PDSCH.

The PDSCH can include information regarding an interference signal for a downlink physical channel to which a radio resource is assigned. For example, the information regarding an interference signal is information regarding an interference signal used when a scheduled PDSCH is detected. The information regarding an interference signal is information necessary for demodulating an interference signal, such as a modulation scheme, information regarding an MCS, information regarding the number of spatial multiplexing, and information regarding an antenna port.

The PDSCH can be used for requiring channel state information of a downlink. As the channel state information, a rank indicator RI for designating the appropriate number of spatial multiplexing, a precoding matrix indicator PMI for designating an appropriate precoding matrix, a channel quality indicator CQI for designating an appropriate transmission rate, and the like are provided.

The PDSCH can be used for indicating information (interference information) regarding an interference which is considered for calculating CSI by a terminal apparatus. For example, the interference information corresponds to information relating to a terminal apparatus other than the terminal apparatus. For example, the interference information is information necessary for demodulating an interference signal, such as a cell ID (virtual cell ID) of the interference signal, information regarding an antenna port, a modulation scheme, information regarding a modulation and coding scheme (MCS), information regarding the number of spatial multiplexing (number of layers), and information regarding transmission power. The information regarding an interference which is considered for calculating CSI can be assumed to have details different from information regarding an interference signal for a downlink physical channel to which the radio resource is assigned.

The PDSCH includes information for designating an interference signal in CSI which is calculated considering the interference signal. For example, in a case where information regarding an interference which is considered for calculating the CSI relates to a plurality of interferences (in a case where a plurality of candidates for an interference signal to be considered for calculating CSI is provided), information (for example, Index of an interference signal to be considered) indicating an interference signal to be considered when CSI is calculated, among the plurality of interference signals is included.

A base station apparatus can include information regarding a configuration of a CSI-IM (CSI-Interference Measurement) resource, in the PDSCH. The base station apparatus can include information indicating whether or not the configuration of a CSI-IM resource is provided, as the information regarding the configuration of the CSI-IM resource. The base station apparatus can include information indicating resource for configuring the CSI-IM, as the information regarding the configuration of the CSI-IM resource. The base station apparatus can include a bitmap indicating resource for configuring the CSI-IM, as the information regarding the configuration of the CSI-IM resource. For example, the base station apparatus can measure interference from other cells by using resources for configuring the CSI-IM resource.

The base station apparatus can include a channel state information process (CSI process) which corresponds to a configuration relating to a report of channel state information, in the PDSCH. The CSI process can include a configuration relating to a procedure of calculating channel state information in association with at least a CSI-RS (CSI-Reference Signal) and a CSI-IM resource. The CSI process can include a CSI process ID thereof.

The base station apparatus can configure at least one CSI process. The base station apparatus can separately generate feedback of CSI for each CSI process. The base station apparatus can perform a configuration so as to have a different CSI-RS and a different CSI-IM resource for each CSI process. The base station apparatus can configure a plurality of CSI processes for one terminal apparatus.

The base station apparatus can include information regarding an interference which is considered for calculating CSI by the terminal apparatus, in the CSI process. The base station apparatus can individually configure the information regarding an interference which is considered for calculating CSI, for each CSI process. Thus, since separately configuring information regarding an interference, for each CSI process is possible, the base station apparatus can flexibly perform a configuration relating to measurement of CSI for the terminal apparatus. Thus, flexible scheduling for the terminal apparatus is allowed in the base station apparatus, and transmission efficiency is significantly improved.

Even in a case where the base station apparatus configures a plurality of CSI processes in the terminal apparatus, the base station apparatus may configure information regarding one interference, in the terminal apparatus. That is, a configuration of information regarding one interference is applied to a plurality of CSI processes. Thus, it is possible to reduce an information quantity for transmitting information regarding one interference.

The base station apparatus can individually configure the information regarding an interference which is considered for calculating CSI, for each CSI subframe set. Here, the CSI subframe set is bitmap information indicating a subframe used as a base when CSI is generated. Thus, the base station apparatus can report the information regarding an interference which is considered for calculating CSI, to a terminal apparatus which can perform reception processing by using the information regarding an interference.

Even in a case where the base station apparatus configures a plurality of CSI subframe sets in the terminal apparatus, the base station apparatus may configure information regarding one interference, in the terminal apparatus. That is, a configuration of information regarding one interference is applied to a plurality of CSI subframe sets. Thus, it is possible to reduce an information quantity for transmitting information regarding one interference.

The base station apparatus can commonly configure information regarding an interference which is considered for calculating CSI, for all CSI process and/or for each CSI subframe set. Thus, the base station apparatus can simply report the information regarding an interference which is considered for calculating CSI, to a terminal apparatus which can perform reception processing by using the information regarding an interference.

The PDSCH can include information indicating a transmission method (transmission mode) used when the base station apparatus transmits user data (transport block) of a downlink to the terminal apparatus. The transmission mode is predefined in the communication system. The transmission mode is configured through RRC signaling in the terminal apparatuses 200-1, 200-2, and 200-3 by the base station apparatuses 100-1, 100-2, and 100-3. The transmission mode defines the corresponding DCI format. That is, the terminal apparatuses 200-1, 200-2, and 200-3 determine a DCI format of a control channel to be monitored, by a transmission mode which is configured by the base stations 100-1, 100-2, and 100-3.

For example, transmission modes 1 to 10 are predefined in the communication system in FIG. 1. The transmission mode 1 is a transmission mode using a single antenna-port transmission scheme which uses an antenna port 0. The transmission mode 2 is a transmission mode using a transmission diversity method. The transmission mode 3 is a transmission mode using a cyclic delay diversity method. The transmission mode 4 is a transmission mode using a closed-loop spatial multiplexing scheme. The transmission mode 5 is a transmission mode using a multi-user MIMO method. The transmission mode 6 is a transmission mode using a closed-loop spatial multiplexing scheme which uses a single antenna port. The transmission mode 7 is a transmission mode using a single antenna-port transmission scheme which uses an antenna port 5. The transmission mode 8 is a transmission mode using a closed-loop spatial multiplexing scheme which uses antenna ports 7 and 8. The transmission mode 9 is a transmission mode using a closed-loop spatial multiplexing scheme which uses antenna ports 7 to 14. The transmission mode 10 is a transmission mode using a closed-loop spatial multiplexing scheme which uses antenna ports 7 to 14. The transmission mode 10 is a transmission mode in which a notification of a plurality of CSI-RSs (details will be described later) and feedback information of CSI using the CSI-RSs is allowed. For example, the transmission mode 10 can be set as a transmission mode in which CoMP communication is allowed.

The base station apparatus can map a de-modulation RS (DM-RS) on a resource element for a terminal apparatus which configures the transmission modes 8, 9, and 10. The base station apparatus can map a CSI-RS on a resource element for a terminal apparatus which configures the transmission modes 9 and 10. The base station apparatus can map a CSI-RS and a CSI-IM on resource elements for a terminal apparatus which configures the transmission mode 10.

The base station apparatus can transmit the information regarding an interference which is considered for calculating CSI by the terminal apparatus, in all of the transmission modes. Thus, the base station apparatus can report the information regarding an interference which is considered for calculating CSI, to a terminal apparatus which can perform reception processing by using the information regarding an interference.

The base station apparatus can transmit the information regarding an interference which is considered for calculating CSI by a terminal apparatus, in the transmission mode 10. Thus, the base station apparatus can report the information regarding an interference which is considered for calculating CSI, to a terminal apparatus which can perform reception processing by using the information regarding an interference, in a case where a CSI-RS or a CSI-IM can be configured.

The base station apparatus can transmit the information regarding an interference which is considered for calculating CSI by a terminal apparatus, in the transmission modes 9 and 10. Thus, the base station apparatus can report the information regarding an interference which is considered for calculating CSI, to a terminal apparatus which can perform reception processing by using the information regarding an interference, in a case where a CSI-RS can be configured.

The base station apparatus can transmit the information regarding an interference which is considered for calculating CSI by a terminal apparatus, in the transmission modes 8, 9, and 10. Thus, the base station apparatus can report the information regarding an interference which is considered for calculating CSI, to a terminal apparatus which can perform reception processing by using the information regarding an interference, in a case where a DM-RS can be configured. Since the DM-RS is subjected to precoding similarly to downlink data (for example, PDSCH), the terminal apparatus can calculate CSI with high accuracy.

The base station apparatus may configure a transmission mode (for example, transmission mode 11) in which information regarding an interference which is considered for calculating channel state information is transmitted, in addition to the transmission mode. The base station apparatus can report the information regarding an interference which is considered for calculating channel state information, based on whether or not the transmission mode is the transmission mode 11.

The base station apparatus can report the information regarding an interference which is considered for calculating CSI, based on whether the transmission mode is a transmission mode in which the CSI is calculated based on a common reference signal (CRS), or a transmission mode in which the CSI is calculated based on a CSI-RS.

The PDSCH can be used for transmitting an uplink resource for mapping a channel state information report (CSI feedback report) which is subjected to feedback to the base station apparatus by the terminal apparatus. For example, the channel state information report can be used for a configuration indicating an uplink resource for reporting periodic channel state information (Periodic CSI). The channel state information report can be used for a mode configuration (Periodic CSI report mode) for reporting periodic channel state information. In the mode configuration in which the periodic channel state information is reported, if the mode is configured, the periodic channel state information is subjected to feedback until the configured mode is released.

For example, the channel state information report can be used for a configuration indicating an uplink resource for aperiodically reporting channel state information (Aperiodic CSI). The channel state information report can be used for a configuration (CSI report mode) of a mode in which aperiodic channel state information is reported. In the mode configuration in which the aperiodic channel state information is reported, if the mode is configured, the terminal apparatus performs feedback of the channel state information in accordance with a CSI request, every time the request (CSI request) of the channel state information is received.

The base station apparatuses 100-1, 100-2, and 100-3 can configure either of the periodic channel state information report and the aperiodic channel state information report. The base station apparatuses 100-1, 100-2, and 100-3 can configure both of the periodic channel state information report and the aperiodic channel state information report.

In a case where the mode in which the periodic channel state information is reported is configured, the base station apparatus can transmit the information regarding an interference which is considered for calculating CSI by the terminal apparatus, in the channel state information report mode (CSI report mode). Thus, the base station apparatus can periodically report the information regarding an interference which is considered for calculating CSI, to the terminal apparatus.

In a case where the mode in which the aperiodic channel state information is reported is configured, the base station apparatus can transmit the information regarding an interference which is considered for calculating CSI by the terminal apparatus, in the channel state information report mode (CSI report mode). Thus, the base station apparatus can adaptively report the information regarding an interference which is considered for calculating CSI, to the terminal apparatus.

The PDSCH can be used for transmitting the type of the channel state information report which is subjected to feedback to the base station apparatus by the terminal apparatus. As the type of the channel state information report, a wide-band CSI (for example, Wideband CQI), a narrow-band CSI (for example, Subband CQI), and the like are provided. In the wide-band CSI, one piece of channel state information for a system band of a cell is calculated. For example, one piece of channel state information for a system bandwidth in FIG. 2 is calculated. In the narrow-band CSI, the system band is divided by a predetermined unit, and one piece of channel state information for each of the divided parts is calculated.

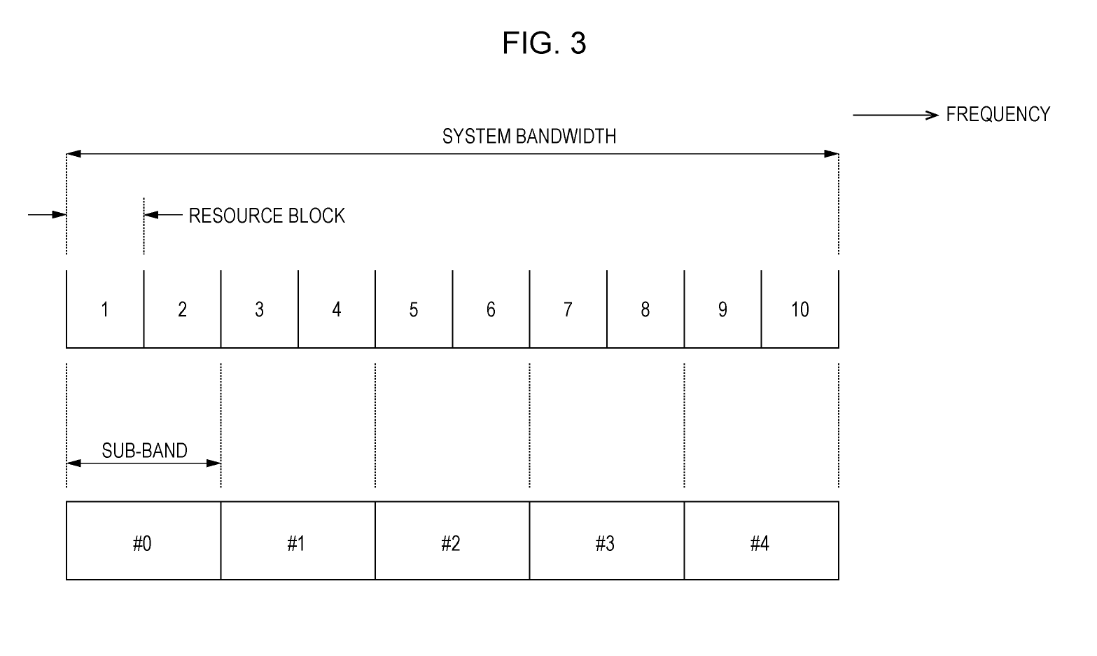

FIG. 3 is a diagram illustrating an example in which the narrow-band CSI is calculated in the embodiment. In the communication system according to the embodiment, the system bandwidth is configured from a plurality of resource blocks. As illustrated in FIG. 2, the resource block is a block configured by a plurality of resource elements. FIG. 3 illustrates an example of the system bandwidth which is configured from 10 resource blocks.

The system bandwidth is divided into groups (sub-bands in FIG. 3. Being referred below to as sub-bands). The group is configured from a plurality of resource blocks. The number of sub-bands can be calculated based on a configuration (number of resource block constituting the sub-band) of the sub-band size. The sub-band size can be configured based on the system bandwidth. 3 is an example of a case where the sub-band size is 2. All sub-bands may have the same size as each other, or sub-bands having a size different from each other may be provided.

The sub-band size can be configured in the system in advance. An index can be given to the sub-band configured from the plurality of resource blocks.

In a case where the narrow-band CSI is calculated in FIG. 3, a CSI value is calculated in a unit of a sub-band configured from the plurality of resource blocks. For example, the CSI value can be set as a CSI value which can be received with predetermined reception quality by the terminal apparatus. The predetermined reception quality can be set to be a predetermined error rate.

The sub-band size (number of resource blocks) can be configured so as to vary depending on whether or not the advanced reception function is applied. For example, in the same system bandwidth, the size for constituting the sub-band in a case where the advanced reception function is applied can be smaller than the size in a case where the advanced reception function is to be applied. That is, the number of sub-bands in a case where the advanced reception function is applied can be set to be more than the number of sub-bands in a case where the advanced reception function is to be applied, in the same system bandwidth.

In FIG. 3, the terminal apparatus can report one CSI value for all sub-bands constituting the system bandwidth, to the base station apparatus. The terminal apparatus can select sub-bands of which the number is appropriate, among the sub-bands constituting the system bandwidth. The terminal apparatus can report one CSI value for the selected sub-bands, to the base station apparatus. The terminal apparatus can report indices of the selected sub-bands. The indices of the sub-bands can be reported along with the CSI value. In FIG. 3, a report mode configuration of the narrow-band CSI can be transmitted to the terminal apparatus by the base station apparatus. For example, the base station apparatus can perform transmission by using the PDCCH and PDSCH. The number of selected sub-bands can be configured based on the system bandwidth. The appropriate number of sub-bands to be reported can be configured in the system in advance.

In FIG. 3, CSI values of both of a narrow-band CSI and a wide-band CSI can be reported. In this case, the CSI value of the narrow-band CSI can be indicated by a difference from the CSI value of the wide-band CSI.

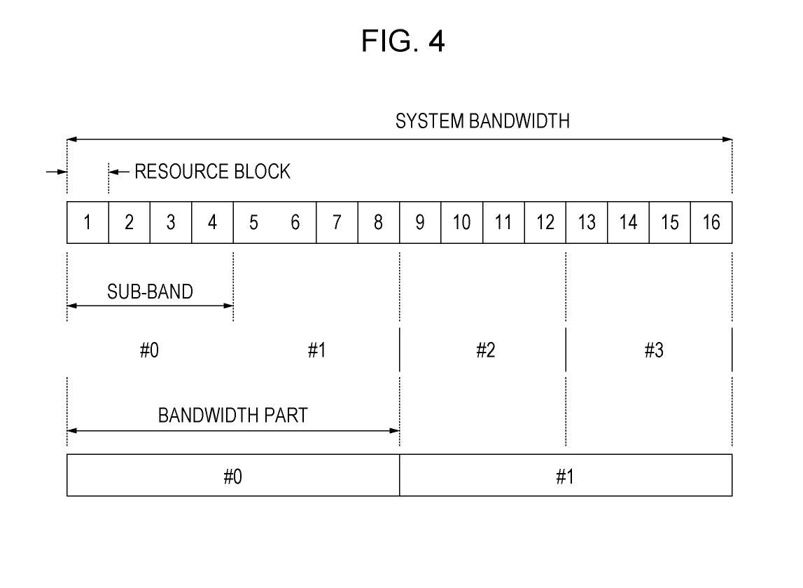

FIG. 4 is a diagram illustrating another example in which a narrow-band CSI is calculated in the embodiment. In the communication system according to the embodiment, the system bandwidth is configured from a plurality of resource blocks. FIG. 4 illustrates a configuration example in which the system bandwidth is configured from 16 resource blocks.

The system bandwidth is divided into groups (sub-bands in FIG. 4. Being referred below to as sub-bands). The group is configured from a plurality of resource blocks. The number of sub-bands can be calculated based on a configuration (number of resource block constituting the sub-band) of the sub-band size. The sub-band size can be configured based on the system bandwidth. An index can be given to the sub-band configured from the plurality of resource blocks.

The system bandwidth is divided into groups (bandwidth parts in FIG. 4. Being referred below to as bandwidth parts). The group is configured from a plurality of sub-bands. The number of bandwidth parts can be configured based on the system bandwidth. An index can be given to the bandwidth part.

The sub-band size and the number of band parts can be configured in the system in advance. FIG. 4 illustrates an example of a case where the sub-band size is 4, and the number of bandwidth parts is 2.

In a case where the narrow-band CSI is calculated in FIG. 4, a CSI value is calculated in a unit of a sub-band configured from the plurality of resource blocks. For example, the CSI value can be set as a CSI value which can be received with predetermined reception quality by the terminal apparatus. The predetermined reception quality can be set to be a predetermined error rate.

In FIG. 4, the terminal apparatus can select sub-bands of which the number is appropriate, among a plurality of sub-bands constituting a bandwidth part, in each bandwidth part. The terminal apparatus can report one CSI value for the selected sub-bands, to the base station apparatus. The appropriate predetermined number of sub-bands can be configured in the system in advance. For example, in a case where the appropriate predetermined number of sub-bands is 1, regarding the bandwidth part index #0 in FIG. 4, a sub-band index having an appropriate CSI value, out of the sub-band index #0 and the sub-band index #1 is selected. The CSI value of the selected sub-band index is reported to the base station apparatus.

Sub-bands of which the number can be appropriately predetermined are selected among a plurality of sub-bands constituting a bandwidth part in each bandwidth part. In a case of a mode configuration in which one CSI value for the selected sub-bands is reported to the base station apparatus, indices of the selected sub-bands can be reported. The indices of the sub-bands can be subjected to signaling along with the CSI value. In FIG. 4, the base station apparatus can transmit the report mode configuration of the narrow-band CSI, to the terminal apparatus. For example, a notification of using the PDCCH and PDSCH can be performed.

In FIG. 4, the terminal apparatus can sequentially report the CSI value of each bandwidth part or/and the sub-band index to the base station apparatus. In FIG. 4, CSI values of both of a narrow-band CSI and a wide-band CSI can be reported. In this case, the CSI value of the narrow-band CSI can be indicated by a difference from the CSI value of the wide-band CSI.

In a case where a configuration including a wide-band CSI is made as feedback of channel state information, the base station apparatus can transmit information regarding an interference which is considered for calculating CSI by the terminal apparatus. Thus, in a case where statistical interference in the system band is suppressed, it is possible to hold reception quality in the system band to be constant.

In a case where a configuration including a narrow-band CSI is made as feedback of channel state information, the base station apparatus can transmit information regarding an interference which is considered for calculating CSI by the terminal apparatus. Thus, it is possible to delicately configure a CSI value considering interference, with regard to a channel state.

The PDSCH can be used for transmitting a mode configuration which is determined from a configuration of the periodic channel state information report or the aperiodic channel state information report, and a configuration of the type of the channel state information report. Examples of the mode configuration include a mode in which the aperiodic channel state information report is performed, and a wide-band CSI is reported; a mode in which the aperiodic channel state information report is performed, and a narrow-band CSI is reported; aperiodic channel state information report, a wide-band CSI and a narrow-band CSI; a mode in which the periodic channel state information report is performed, and a wide-band CSI is reported; a mode in which periodic channel state information report is performed, and a narrow-band CSI is reported; a mode in which the periodic channel state information report is performed, and a wide-band CSI and a narrow-band CSI are reported. The base station apparatus can perform a configuration of transmitting information regarding an interference which is considered for calculating CSI by the terminal apparatus, based on the mode configuration, as feedback of the channel state information.

The base station apparatus can perform a different configuration for each element (RI, PMI, CQI, and the like) constituting CSI. The base station apparatus can perform a configuration in which only some of elements (RI, PMI, CQI, and the like) constituting CSI are subjected to feedback. For example, the base station apparatus can perform a configuration in which only a CQI is subjected to feedback.

In a case where a PMI and a RI are configured as feedback of channel state information, the base station apparatus can transmit information regarding interference which is considered for calculating CSI by the terminal apparatus. Thus, the terminal apparatus can calculate the PMI and the RI considering the interference, and perform feedback. Accordingly, the base station apparatus can configure number of spatial multiplexing in accordance with a channel situation, with higher accuracy.

The PMCH is used for transmitting multicast data (MCH: Multicast Channel).

In FIG. 1, a downlink physical channel is used in a radio communication using the downlink signals r101, r103, and r105 from the base station apparatuses 100-1, 100-2, and 100-3 to the terminal apparatuses 200-1, 200-2, and 200-3. The downlink physical channel is not used for transmitting information which has been output from a higher layer, but is used by a physical layer. The downlink physical signal includes a synchronization signal (SS), a downlink-reference signal (DL-RS), and the like.

The synchronization signal is used for performing synchronization of a downlink in the frequency domain and the time domain by the terminal apparatuses 200-1, 200-2, and 200-3.

The downlink-reference signal is used for performing channel correction of a downlink physical channel by the terminal apparatuses 200-1, 200-2, and 200-3. The downlink-reference signal may be used for calculating channel state information of a downlink by the terminal apparatuses 200-1, 200-2, and 200-3. Examples of the type of the downlink-reference signal include a cell-specific reference signal (CRS), an UE-specific reference signal (URS) associated with a PDSCH, a demodulation reference signal (DMRS) associated with an EPDCCH, a non-zero power channel state information-reference signal (NZP CSI-RS), a zero power channel state information-reference signal (ZP CSI-RS), a multimedia broadcast and multicast service over single frequency network reference signal (MBSFN RS), and a positioning reference signal (PRS).

The CRS is transmitted in the entire band of a subframe. The CRS is used for demodulating a PBCH, a PDCCH, a PHICH, a PCFICH, a PDSCH, and the like. The CRS may be used when the terminal apparatuses 200-1, 200-2, and 200-3 calculate channel state information of a downlink. The PBCH, the PDCCH, the PHICH, and the PCFICH are transmitted on an antenna port which is used in transmission of the CRS.

The URS associated with a PDSCH is transmitted in a subframe and a band used in transmission of a PDSCH associated with the URS. The URS is used for demodulating a PDSCH associated with the URS.

The PDSCH is transmitted on an antenna port which is used in transmission of the CRS or the URS. The DCI format 1A is used in scheduling the PDSCH which is transmitted on an antenna port used in transmission of the CRS. For example, the CRS is transmitted on one or several of antenna ports 0 to 3.

The DMRS associated with an EPDCCH is transmitted in a subframe and a band used in transmission of an EPDCCH with which the DMRS is associated. The DMRS is used for demodulating the EPDCCH with which the DMRS is associated. The EPDCCH is transmitted on an antenna port used in transmission of the DMRS.

The NZP CSI-RS is transmitted in a configured subframe. A resource in which the NZP CSI-RS is transmitted is configured by the base station apparatus. The NZP CSI-RS is used when the terminal apparatuses 200-1 and 200-2 calculate channel state information of a downlink. The terminal apparatuses 200-1 and 200-2 perform signal measurement (channel measurement) by using the NZP CSI-RS.

Resources of the ZP CSI-RS are configured by the base station apparatuses 100-1, 100-2, and 100-3. The base station apparatus transmits the ZP CSI-RS with zero output. That is, the base station apparatuses 100-1, 100-2, and 100-3 do not transmit the ZP CSI-RS in the configured resources of the ZP CSI-RS. The base station apparatuses 100-1, 100-2, and 100-3 do not transmit the PDSCH and the EPDCCH in the configured resources of the ZP CSI-RS. For example, the terminal apparatus can measure interference between resources corresponding to the NZP CSI-RS, in a certain cell.

The MBSFN RS is transmitted in the entire band of a subframe which is used in transmission of the PMCH. The MBSFN RS is used for demodulating the PMCH. The PMCH is transmitted on an antenna port used in transmission of the MBSFN RS.

The PRS is used when a terminal apparatus measures the geographical position of the terminal apparatus.

An uplink physical channel is used in a radio communication using the uplink signals r101, r103, and r105 from the terminal apparatuses 200-1, 200-2, and 200-3 to the base station apparatuses 100-1, 100-2, and 100-3. The uplink physical channel can be used for transmitting information which has been output from a higher layer. The uplink physical channel includes a physical uplink control channel (PUCCH), a physical uplink shared channel (PUSCH), a physical random access channel (PRACH), and the like.

The PUCCH is used for transmitting uplink control information (UCI). The uplink control information includes channel state information (CSI) of a downlink and a scheduling request (SR) indicating a request of a PUSCH resource. As the channel state information, a rank indicator RI for designating the appropriate number of spatial multiplexing, a precoding matrix indicator PMI for designating a suitable precoder, a channel quality indicator CQI for designating an appropriate transmission rate, and the like are provided.

The channel quality indicator CQI (below, CQI value) can include an appropriate modulation scheme (for example, QPSK, 16QAM, 64QAM, 256QAM, and the like), and an appropriate coding rate (code rate) in a predetermined band. The CQI value can be indicated by an index (CQI Index) which is determined by the change method or the coding rate. The CQI value can be set to be predetermined in the corresponding system.

The rank indicator and the precoding quality indicator can be set to be predetermined in the system. The rank indicator or the precoding matrix indicator can be set to be the number of spatial multiplexing or an index determined by precoding matrix information. Values of the rank indicator, the precoding matrix indicator, and the channel quality indicator CQI are collectively referred to as a CSI value.

The uplink control information includes acknowledgement (ACK)/negative-acknowledgement (NACK) in response to downlink data (Downlink Transport block, Downlink-Shared Channel: DL-SCH). Here, ACK/NACK is also referred to as HARQ-ACK, HARQ feedback, or response information. The PUCCH may be used when the terminal apparatus transmits the information regarding the advanced reception function. The PUCCH may be used for transmitting information (UE Capability) which indicates that the terminal apparatus includes the advanced reception function.

The PUSCH is used for transmitting uplink data (Upink Transport block, Uplink-Shared Channel: UL-SCH). That is, transmission of uplink data on an UL-SCH is performed through the PUSCH. That is, the UL-SCH which is a transport channel is mapped on the PUSCH which is a physical channel. The PUSCH may be used for transmitting HARQ-ACK and/or channel state information along with the uplink data. The PUSCH may be used for transmitting only channel state information or for transmitting only HARQ-ACK and channel state information.

The PUSCH is used for transmitting an RRC message. The RRC message is information/signal processed in a radio resource control (RRC) layer. The RRC message may be used when the terminal apparatus transmits the information regarding the advanced reception function. The RRC message may be used for transmitting information which indicates that the terminal apparatus includes the advanced reception function. The PUSCH is used for transmitting an MAC control element (CE). Here, the MAC CE is information/signal processed (transmitted) in a medium access control (MAC) layer. The MAC CE may be used when the terminal apparatus transmits the information regarding the advanced reception function. The MAC CE may be used for transmitting information which indicates that the terminal apparatus includes the advanced reception function.

The PRACH is used for transmitting a random access preamble. The PRACH is used for indicating an initial connection establishment procedure, a handover procedure, a connection re-establishment procedure, synchronization (timing adjustment) with uplink transmission, and a request of PUSCH resources.

An uplink physical signal is used in a radio communication using the uplink signals r101, r103, and r105 from the terminal apparatuses 200-1, 200-2, and 200-3 to the base station apparatuses 100-1, 100-2, and 100-3. The uplink physical signal is not used for transmitting information which has been output from a higher layer, but is used by a physical layer. The uplink physical signal includes an uplink reference signal (UL RS). The uplink reference signal includes a demodulation reference signal (DMRS) and a sounding reference signal (SRS).

The DMRS is associated with transmission of a PUSCH or a PUCCH. The DMRS is subjected to time multiplexing along with the PUSCH or the PUCCH. For example, the base station apparatuses 100-1, 100-2, and 100-3 use a DMRS for performing channel correction of the PUSCH or the PUCCH.

The SRS is not associated with transmission of a PUSCH or a PUCCH. The base station apparatuses 200-1, 200-2, and 200-3 use the SRS for measuring a channel state of an uplink. The terminal apparatuses 200-1, 200-2, and 200-3 transmit a first SRS in a first resource configured by a higher layer. In a case where the terminal apparatuses 200-1, 200-2, and 200-3 receive information indicating that transmission of the SRS is required on a PDCCH, the terminal apparatuses 200-1, 200-2, and 200-3 transmit a second SRS in a second resource configured by the higher layer, only once. Here, the first SRS is also referred to as a periodic SRS or a type-0-triggered SRS. The second SRS is also referred to as an aperiodic SRS or a type-1-triggered SRS.

The downlink physical channels and the downlink physical signal are also collectively referred to as downlink signals. The uplink physical channels and the uplink physical signals are also collectively referred to as uplink signals. The downlink physical channels and the uplink physical channels are also collectively referred to as physical channels. The downlink physical signals and the uplink physical signals are also collectively referred to as physical signals.

The BCH, the MCH, the UL-SCH, and the DL-SCH are transport channels. Channels which are used in a medium access control (MAC) layer are referred to as transport channels. A unit of a transport channel which is used in the MAC layer is also referred to as a transport block (TB) or a MAC protocol data unit (PDU). Control of a Hybrid Automatic Repeat reQuest (HARQ) is performed for each transport block in the MAC layer. The transport block is a unit of data which is delivered to a physical layer by the MAC layer. In the physical layer, the transport block is mapped to a code word, and coding processing is performed for each code word.

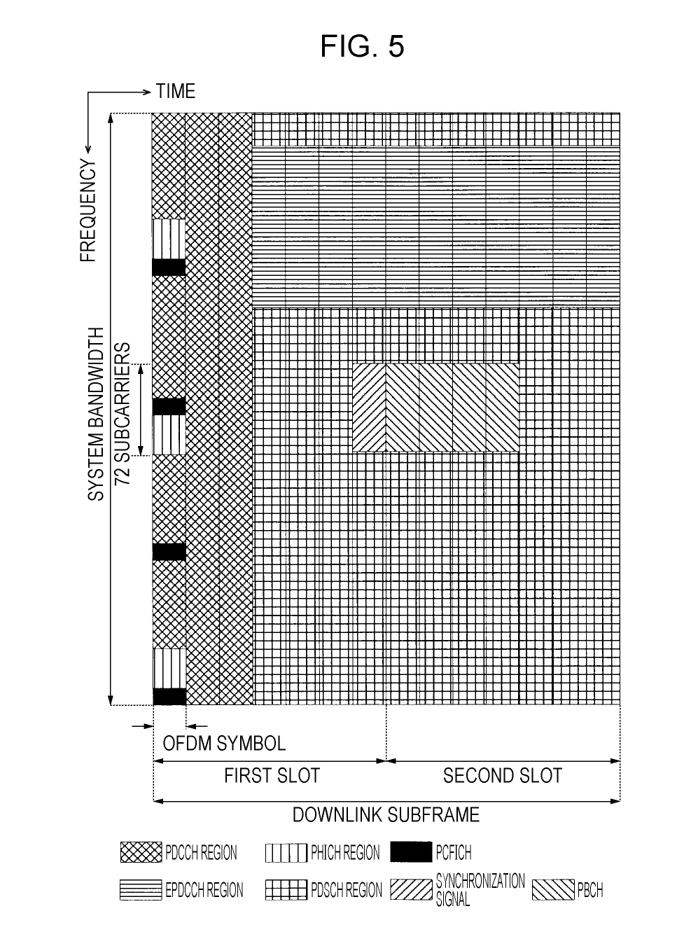

FIG. 5 is a diagram showing an example of the mapping of physical channels and physical signals in a downlink subframe, in the embodiment. In FIG. 5, a horizontal axis indicates a time axis, and a vertical axis indicates a frequency axis. The base station apparatuses 100-1, 100-2, and 100-3 may transmit a downlink physical channel (PBCH, PCFICH, PHICH, PDCCH, EPDCCH, PDSCH) and a downlink physical signal (synchronization signal, downlink reference signal) in a downlink subframe. Here, for simple descriptions, the downlink reference signal is not illustrated in FIG. 3.

In a region of the PDCCH, a plurality of PDCCHs may be subjected to frequency multiplexing and time multiplexing. In an EPDCCH region, a plurality of EPDCCHs may be subjected to frequency multiplexing, time multiplexing, and spatial multiplexing. In a region of the PDSCH, a plurality of PDSCHs may be subjected to frequency multiplexing and spatial multiplexing. The PDCCH, and the PDSCH, or the EPDCCH may be subjected to time multiplexing. The PDSCH and EPDCCH may be subjected to frequency multiplexing.

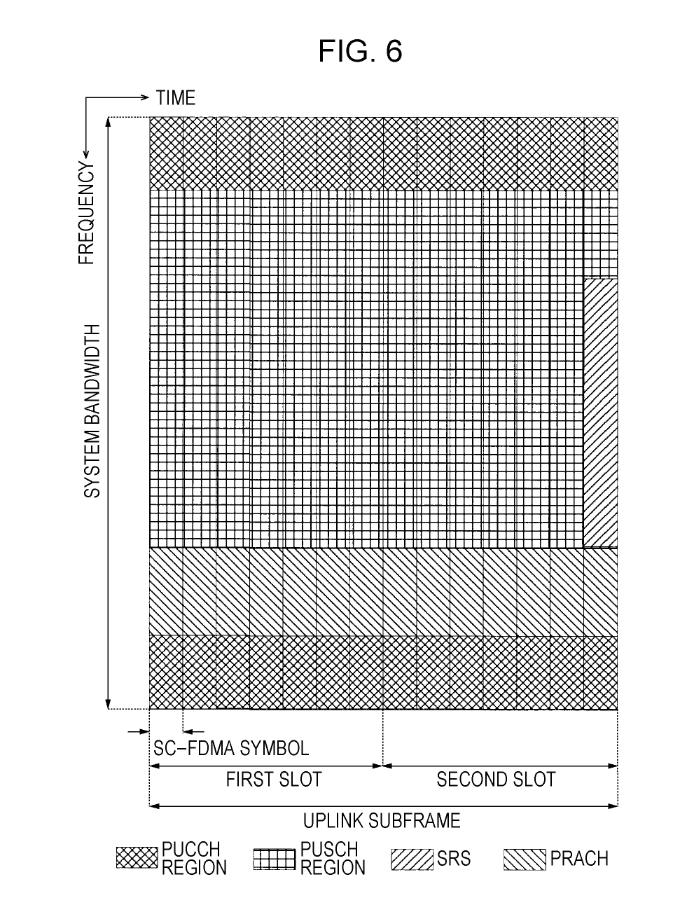

FIG. 6 is a diagram illustrating an example of mapping of physical channels and physical signals in an uplink subframe, in the embodiment. In FIG. 4, a horizontal axis indicates a time axis, and a vertical axis indicates a frequency axis. The terminal apparatuses 200-1, 200-2, and 200-3 may transmit an uplink physical channel (PUCCH, PUSCH, PRACH) and an uplink physical signal (DMRS, SRS) in an uplink subframe.

In a region of the PUCCH, a plurality of PUCCHs may be subjected to frequency multiplexing, time multiplexing, and code multiplexing. In a PUSCH region, a plurality of PUSCHs may be subjected to frequency multiplexing, and spatial multiplexing. The PUCCH and the PUSCH may be subjected to frequency multiplexing. The PRACH may be assigned over a single subframe or two subframes. A plurality of PRACHs may be subjected to code multiplexing.

An SRS may be transmitted by using the last SC-FDMA symbol in an uplink subframe. In a single uplink subframe in a single cell, the terminal apparatuses 200-1, 200-2, and 200-3 perform transmission on a PUSCH and/or PUCCH by using SC-FDMA symbols except for the last SC-FDMA symbol in the uplink subframe. In the single uplink subframe in the single cell, the terminal apparatuses 200-1, 200-2, and 200-3 can perform transmission of an SRS by using the last SC-FDMA symbol in the uplink subframe.

That is, in the single uplink subframe in the single cell, the terminal apparatuses 200-1, 200-2, and 200-3 can perform both of transmission of the SRS and transmission on the PUSCH or/and the PUCCH. The DMRS may be subjected to time multiplexing along with the PUCCH or the PUSCH. For simple descriptions, the DMRS is not illustrated in FIG. 6.

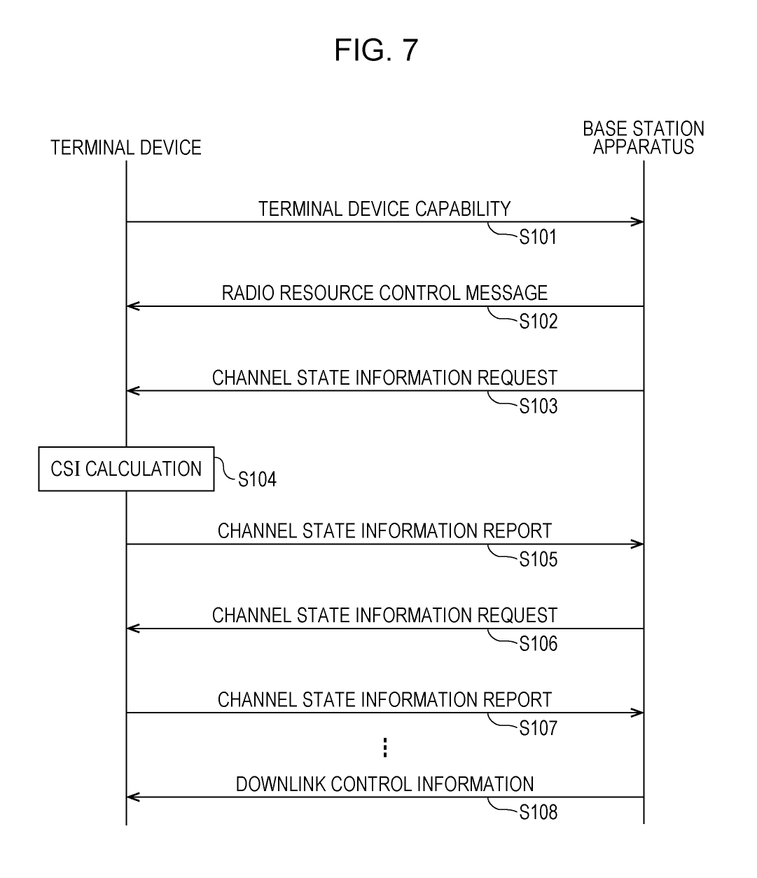

FIG. 7 is a diagram illustrating a sequence in a case where channel state information is aperiodically reported, in the embodiment. In FIG. 7, a terminal apparatus reports capability (UE capability) of the terminal apparatus to a base station apparatus (S101). The terminal apparatus can transmit information indicating a configurable transmission mode by using the capability, to the base station apparatus. The base station apparatus can determine whether or not configuring interference information for the terminal apparatus is possible, by using the information indicating the configurable transmission mode.

The terminal apparatus can transmit information indicating that using a CSI-RS is possible, to the base station apparatus by the capability. The terminal apparatus can transmit a message indicating that the advanced reception function is provided, to the base station apparatus by the capability. The terminal apparatus can receive a cell-specific downlink reference signal (CRS and the like).

In FIG. 7, the base station apparatus can transmit a radio resource control message (RRC message) (S102). The base station apparatus can include information indicating a transmission mode configuration, in the RRC message. The terminal apparatus can recognize that the RRC message includes information regarding interference which is considered for calculating CSI, by the information indicating a transmission mode configuration.

In FIG. 7, the base station apparatus can include a channel state information report configuration for the terminal apparatus, in the RRC message (S102). The base station apparatus transmits a mode configuration in which a wide-band CSI report is subjected to feedback, and a mode configuration in which a narrow-band CSI report is subjected to feedback, to the terminal apparatus by the channel state information report configuration. The base station apparatus can transmit a mode configuration (mode configuration in which a CSI value is transmitted for all sub-bands, or mode configuration in which CSI is transmitted for sub-bands of which the number is appropriately predetermined) in the narrow-band CSI report. The terminal apparatus can recognize that the RRC message includes information regarding interference which is considered for calculating CSI, by the channel state information report configuration.

The base station apparatus can perform the periodic channel state information report or the aperiodic channel state information report configuration, by the channel state information report configuration (S102). The terminal apparatus can recognize that the RRC message includes information regarding interference which is considered for calculating CSI, by the periodic channel state information report or the aperiodic channel state information report configuration.

The base station apparatus can perform the periodic channel state information report or the aperiodic channel state information report configuration, and a mode configuration which includes a configuration of the type of the channel state information report, by the channel state information report configuration (S102). Examples of the mode configuration include a mode in which the aperiodic channel state information report is performed, and a wide-band CSI is reported, a mode in which the aperiodic channel state information report is performed, and a narrow-band CSI is reported, a mode in which the aperiodic channel state information report is performed, and a wide-band CSI and a narrow-band CSI are reported, a mode in which the periodic channel state information report is performed, and a wide-band CSI is reported, a mode in which periodic channel state information report is performed, and a narrow-band CSI is reported, a mode in which the periodic channel state information report is performed, and a wide-band CSI and a narrow-band CSI are reported. The terminal apparatus can recognize that the RRC message includes information regarding interference which is considered for calculating CSI, by the periodic channel state information report or the aperiodic channel state information report configuration, and the mode configuration which includes the configuration of the type of the channel state information report.

In the channel state information report configuration, the periodic channel state information report or the aperiodic channel state information report configuration, and the configuration of the type of the channel state information report can be assigned to physical channels different from each other. For example, the periodic channel state information report or the aperiodic channel state information report can be transmitted on a PDSCH. The configuration of the type of the channel state information report can be transmitted on a PDCCH.

The base station apparatus can include a CSI process in the RRC message (S102). The terminal apparatus can recognize information regarding interference which is considered for calculating CSI, which is included in the CSI process. In a case where the terminal apparatus recognizes that the information regarding interference which is considered for calculating CSI is included, by the transmission mode configuration, the terminal apparatus can monitor the information regarding interference which is considered for calculating CSI, which is included in the CSI process.

In a case where the terminal apparatus recognizes that the information regarding interference which is considered for calculating CSI is included, by the channel state information report configuration, the terminal apparatus can monitor the information regarding interference which is considered for calculating CSI, which is included in the CSI process.

The base station apparatus transmits a mode configuration for the aperiodic channel state information report or/and a mode configuration for the periodic channel state information report, to the terminal apparatus by transmitting the channel state information report configuration. A case of the mode configuration for the aperiodic channel state information report will be described below.

The base station apparatus transmits a channel state information request (CSI request) to the terminal apparatus (S103). For example, the channel state information request can be transmitted on a PDCCH. The channel state information request can include a mode configuration for the wide-band CSI or a mode configuration for the narrow-band CSI.

In a case where the terminal apparatus receives the channel state information request, the terminal apparatus calculates channel state report (CSI) (S104). In a case where the information regarding interference which is considered for calculating CSI is acquired by the RRC message, the terminal apparatus can calculate the CSI by using the information regarding interference which is considered for calculating CSI. When the CSI is calculated, the terminal apparatus can use a cell-specific downlink reference signal (CRS and the like). When the CSI is calculated, the terminal apparatus can use a UE-specific downlink reference signal (CSI-RS and the like).

After receiving the channel state information request, the terminal apparatus performs feedback of a report of channel state information (CSI) to the base station apparatus by using a predetermined subframe (S105). For example, the terminal apparatus performs feedback of the channel state information report, in accordance with resource assignment of a PUSCH, which is included in the transmitted PDCCH. The terminal apparatus can perform feedback of the channel state information report, in accordance with resource assignment determined by using a reception timing of the PDCCH as a base. The terminal apparatus performs feedback of a CSI value according to the channel state information report configuration, as the channel state information report.

In FIG. 7, the terminal apparatus reports channel state information to the base station apparatus every time a request of the downlink channel state information is received from the base station apparatus (S106 and S107).

The base station apparatus transmits downlink control information to the terminal apparatus (S108). The base station apparatus can configure the downlink control information such as a modulation scheme, CSI, and the number of spatial multiplexing, by using the channel state information report which has been subjected to feedback from the terminal apparatus.

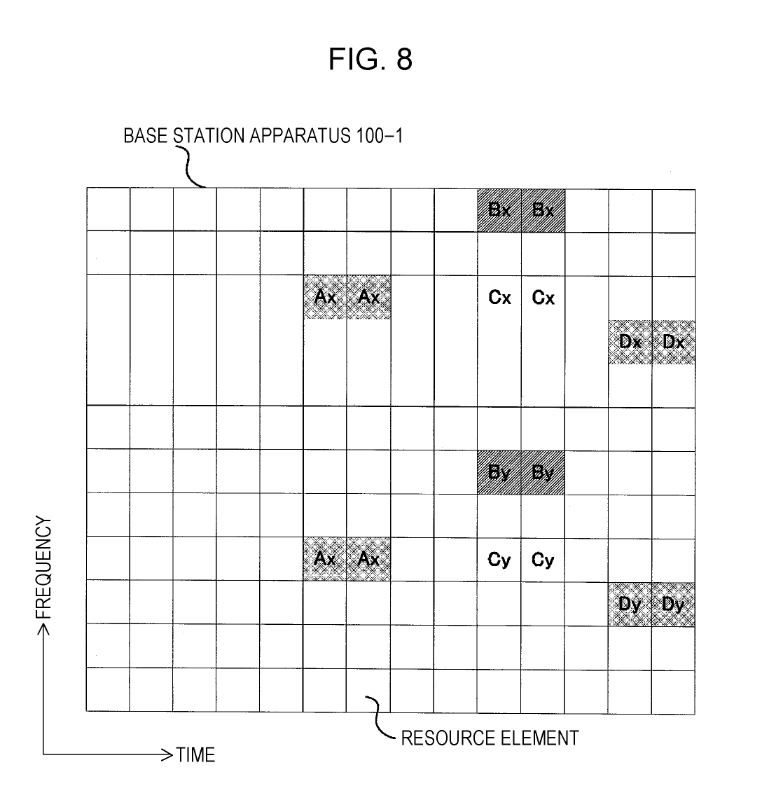

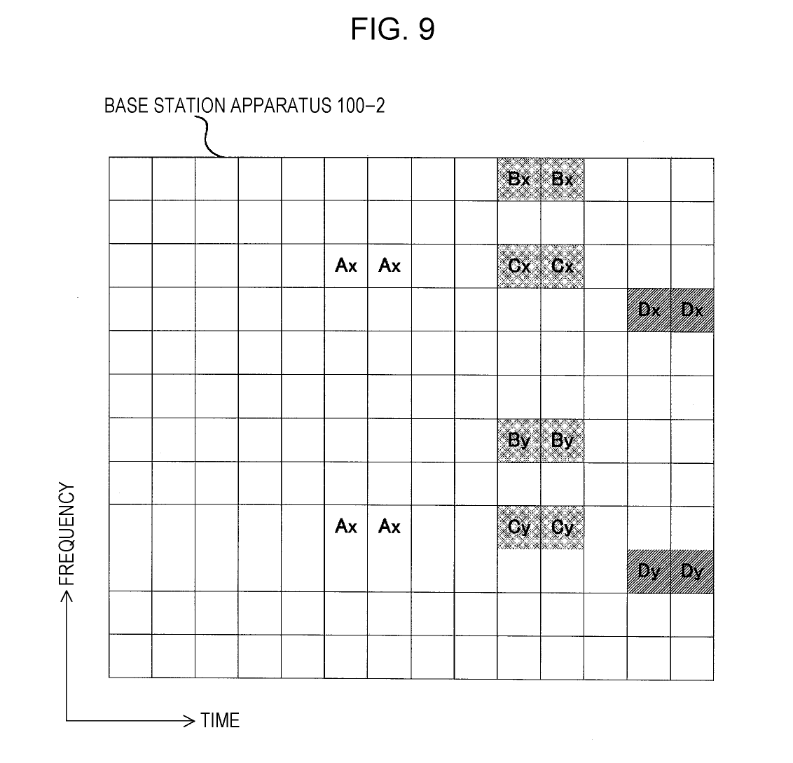

An example in which the base station apparatus 100-1 calculates CSI by using the information regarding interference which is considered for calculating the CSI, in the embodiment will be described with reference to FIGS. 8 and 9. FIG. 8 is a diagram illustrating an example of mapping a physical channel and a physical signal in a downlink physical resource block of the base station apparatus 100-1 according to the embodiment. In FIG. 8, a horizontal axis indicates a time, and a vertical axis indicates a frequency. FIG. 8 illustrates one physical resource block. In FIG. 8, Ax, Ay, Bx, By, Cx, Cy, Dx, and Dy respectively indicate resource elements to which CSI-RS can be assigned. A shaded portion indicates a resource element in which the base station apparatus 100-1 assigns a NZP CSI-RS to the terminal apparatus 200-1. An upper-right slanted line portion indicates a resource element in which the base station apparatus 100-1 assigns a ZP CSI-RS to the terminal apparatus 200-1. A white portion indicates a resource element in which a signal or a channel such as a PDSCH, a PUSCH, and a CRS, which excludes a CSI0-RS can be mapped.

FIG. 9 is a diagram illustrating an example of mapping a physical channel and a physical signal in a downlink physical resource block of the base station apparatus 100-2 according to the embodiment. In FIG. 9, a horizontal axis indicates a time, and a vertical axis indicates a frequency. FIG. 9 illustrates one physical resource block. In FIG. 9, Ax, Ay, Bx, By, Cx, Cy, Dx, and Dy respectively indicate resource elements to which CSI-RS can be assigned. A shaded portion indicates a resource element in which the base station apparatus 100-1 assigns a NZP CSI-RS to the terminal apparatus 200-1. An upper-right slanted line portion indicates a resource element in which the base station apparatus 100-1 assigns a ZP CSI-RS to the terminal apparatus 200-1. A white portion indicates a resource element in which a signal or a channel such as a PDSCH, a PUSCH, and a CRS, which excludes a CSIO-RS can be mapped.

The terminal apparatus 200-1 recognizes that a NZP CSI-RS is assigned to the resource blocks Ax, Ay, Dx, and Dy, and a ZP CSI-RS is assigned to the resource blocks Bx and By, by information regarding a configuration of a CSI-RS, which is included in the CSI process 0 received from the base station apparatus 100-1. The terminal apparatus 200-1 monitors the resource.

The terminal apparatus 200-1 recognizes that the resource blocks Bx and By are used in a CSI-IM, by information regarding a configuration of the CSI-IM, which is included in the CSI process 0 received from the base station apparatus 100-1. The terminal apparatus 200-1 specifies the base station apparatus 100-2 functioning as other cell interference, by information regarding an interference which is considered for calculating CSI, which is included in the CSI process 0 received from the base station apparatus 100-1. For example, the terminal apparatus 200-1 specifies transmission power, the number of antennae, and the antenna port number in the other cell interference, by the information regarding an interference which is considered for calculating CSI. The terminal apparatus 200-1 may specify resource assignment in the other cell interference, by the information regarding an interference which is considered for calculating CSI. For example, the terminal apparatus 200-1 specifies assignment of at least a CSI-RS of the base station apparatus 100-2 illustrated in FIG. 9.

The terminal apparatus 200-1 acquires a signal of a NZP CSI-RS transmitted from the base station apparatus 100-2, in the resource elements Bx and By to which a ZP CSI-RS is assigned. Thus, the terminal apparatus 200-1 can measure interference from the base station apparatus 100-2. The terminal apparatus 200-1 acquires a signal of the resource elements Ax and Ay to which a NZP CSI-RS is assigned. Thus, the terminal apparatus 200-1 can measure a channel between the terminal apparatus 200-1 and the base station apparatus 100-1. The terminal apparatus 200-1 calculates CSI by using the interference from the base station apparatus 100-2, and by using the channel between the terminal apparatus 200-1 and the base station apparatus 100-1. The terminal apparatus 200-1 can calculate the CSI considering reception capacity (for example, in a case where the advanced reception function such as a canceller is provided, reception capacity of specified interference) of the terminal apparatus 200-1.

The terminal apparatus 200-1 acquires a signal of the resource elements Dx and Dy to which a NZP CSI-RS is assigned. In the base station apparatus 100-2, the resource elements Dx and Dy are resources to which a ZP CSI-RS is assigned. Thus, the terminal apparatus 200-1 can measure a channel between the terminal apparatus 200-1 and the base station apparatus 100-1 in a state of no interference, by the NZP CSI-RS assigned to the resource elements Dx and Dy. For example, in a case where the terminal apparatus 200-1 includes the advanced reception function such as a canceller, the terminal apparatus 200-1 can calculate CSI in a case where interference can be completely removed.

The base station apparatus 100-1 can configure the CSI process 1 for the terminal apparatus 200-1. The CSI process 1 is different from the CSI process 0. For example, the CSI process 0 corresponds to a configuration for measuring interference from the base station apparatus 100-2. The CSI procell 2 can perform a configuration for measuring interference from the base station apparatus 100-3. The terminal apparatus 200-1 uses the CSI process 2 similarly to the CSI procell 1 and the above descriptions, and thus can calculate CSI considering the interference. Information regarding an interference which is considered for calculating CSI, which is included in the CSI process 1 can be configured so as to be different from information regarding an interference which is considered for calculating CSI, which is included in the CSI procell 2.

The terminal apparatus 200-2 recognizes that a NZP CSI-RS is assigned to the resource blocks Bx, By, Cx, and Cy, and a ZP CSI-RS is assigned to the resource blocks Dx and Dy, by the information regarding a configuration of a CSI-RS, which is included in the CSI process 2 received from the base station apparatus 100-2. The terminal apparatus 200-2 monitors the resource.

The terminal apparatus 200-2 recognizes that the resource blocks Dx and Dy are used in a CSI-IM, by the information regarding a configuration of the CSI-IM, which is included in the CSI process 2 received from the base station apparatus 100-2. The terminal apparatus 200-2 specifies the base station apparatus 100-1 functioning as other cell interference, by information regarding an interference which is considered for calculating CSI, which is included in the CSI process 2 received from the base station apparatus 100-2.

The terminal apparatus 200-2 acquires a signal of a NZP CSI-RS transmitted from the base station apparatus 100-2, in the resource elements Dx and Dy to which a ZP CSI-RS is assigned. Thus, the terminal apparatus 200-2 can measure interference from the base station apparatus 100-1. The terminal apparatus 200-2 acquires a signal of the resource elements Cx and Cy to which a NZP CSI-RS is assigned. Thus, the terminal apparatus 200-2 can measure a channel between the terminal apparatus 200-2 and the base station apparatus 100-2. The terminal apparatus 200-2 calculates CSI by using the interference from the base station apparatus 100-1, and by using the channel between the terminal apparatus 200-2 and the base station apparatus 100-2. The terminal apparatus 200-2 can calculate the CSI considering reception capacity (for example, in a case where the advanced reception function such as a canceller is provided, reception capacity of specified interference) of the terminal apparatus 200-2.

As described above, the CSI process includes information regarding interference which is considered for calculating CSI, and thus the terminal apparatus can calculate the CSI considering interference, for each CSI procell. In addition, the terminal apparatus can perform feedback of the calculated CSI to the base station apparatus.

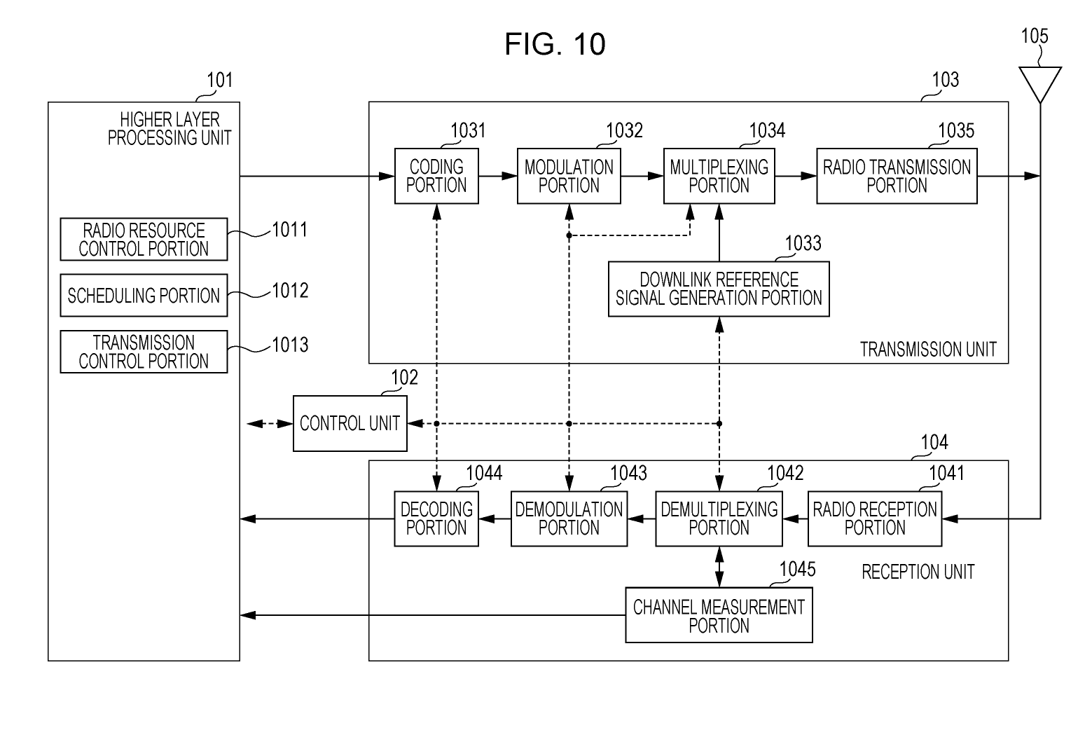

FIG. 10 is a schematic block diagram illustrating a structure of the base station apparatus according to the embodiment. The base station apparatuses 100-1, 100-2, and 100-3 in the embodiment can cooperate with each other in order to require CSI considering other cell interference to the terminal apparatus. In the following descriptions, a case of the base station apparatus 100-1 will be representatively described. As illustrated in FIG. 10, the base station apparatus 100-1 includes a higher layer processing unit 101, a control unit 102, a transmission unit 103, a reception unit 104, and a transmit and receive antenna 105.

The higher layer processing unit 101 includes a radio resource control portion 1011, a scheduling portion 1012, and a transmission control portion 1013. The transmission unit 103 includes a coding portion 1031, a modulation portion 1032, a downlink-reference signal generation portion 1033, a multiplexing portion 1034, and a radio transmission portion 1035. The reception unit 104 includes a radio reception portion 1041, a demultiplexing portion 1042, a demodulation portion 1043, a decoding portion 1044, and a channel measurement portion 1045.

The higher layer processing unit 101 performs processing of a medium access control (MAC) layer, a packet data convergence protocol (PDCP) layer, a radio link control (RLC) layer, and a radio resource control (RRC) layer. The higher layer processing unit 101 generates information necessary for controlling the transmission unit 103 and the reception unit 104, and outputs the generated information to the control unit 102.

The radio resource control portion 1011 generates or acquires downlink data (transport block) mapped on a PDSCH of a downlink, system information, an RRC message, an MAC CE, and the like, from the higher node. The radio resource control portion 1011 outputs a result of the generation or the acquisition to the transmission unit 103, and outputs other information to the control unit 102.

The radio resource control portion 1011 manages various types of setting information/parameters of a terminal apparatus (in FIG. 1, terminal apparatus 100-1) which is connected to the base station apparatus. The radio resource control portion 1011 may set the various types of setting information/parameters for the terminal apparatus through a signal of a higher layer. That is, the radio resource control portion 1011 transmits/reports information indicating the various types of setting information/parameters.

The radio resource control portion 1011 can acquire the information indicating a transmission mode which can be configured by the terminal apparatus 200-1, from the reception unit 104. The radio resource control portion 1011 can acquire information indicating that the terminal apparatus 200-1 can use a CSI-RS, from the reception unit 104. The radio resource control portion 1011 can acquire information indicating that the advanced reception function is provided, from the reception unit 104. The radio resource control portion 1011 can acquire information regarding channel state information report, from the reception unit 104.

The radio resource control portion 1011 can generate information indicating a transmission mode configuration, and output the generated information to the transmission unit 103. The radio resource control portion 1011 can generate a channel state information report configuration and output the generated channel state information report configuration to the transmission unit 103. The radio resource control portion 1011 can generate a CSI process, and output the generated CSI process to the transmission unit 103. In a case where a configuration including the information regarding interference which is considered for calculating CSI is recognized, the radio resource control portion 1011 can include the information regarding interference which is considered for calculating CSI, in the CSI process. The radio resource control portion 1011 can generate information regarding application of the advanced reception function, and output the generated information to the transmission unit 103. The radio resource control portion 1011 can generate a channel state information request, and output the generated channel state information request to the transmission unit 103.

The scheduling portion 1012 determines a frequency and a subframe to which the physical channels (PDSCH and PUSCH) are assigned, the coding rate and the modulation scheme (MCS) of the physical channels (PDSCH and PUSCH), transmission power, and the like, based on the received channel state information (CSI), the estimation value of the channel or the channel quality input from the channel measurement portion 1045, and the like. The scheduling portion 1012 generates control information for controlling the reception unit 104 and the transmission unit 103, based on the scheduling result. The scheduling portion 1012 outputs the generated information to the control unit 102. The scheduling portion 1012 determines a timing at which transmission processing and reception processing is performed.

The transmission control portion 1013 controls the transmission unit 103 to map a PDSCH on a resource element based on an RNTI used in scrambling a CRC parity bit which has been attached to downlink control information, and to perform transmission on the PDSCH. Here, the function of the transmission control portion 1013 may be included in the transmission unit 307.

The higher layer processing unit 101 in the base station apparatus 100-1 can acquire information regarding interference which is considered for calculating CSI, from the higher layer processing unit 101 in the base station apparatus 100-2 which functions as an interference source. For example, the base station apparatus 100-1 can acquire the information through the X2 interface, and the Internet line.

The control unit 102 generates control signals to control the transmission unit 103 and the reception unit 104 based on the information input from the higher layer processing unit 101. The control unit 102 generates downlink control information based on the information input from the higher layer processing unit 101, and output the generated downlink control information to the transmission unit 103. In a case where the terminal apparatus 200-1 can assign a CSI-RS(CSI), the control unit 102 outputs information regarding a sequence or assignment of the CSI-RS (NZP CSI-RS, ZP CSI-RS), to the downlink-reference signal generation portion.

The control unit 102 can acquire information indicating that the advanced reception function is provided, from the reception unit 104. The radio resource control portion 1011 can acquire information regarding the channel state information report, from the reception unit 104. The control unit 102 can input the acquired information to the higher layer processing unit 101.

The transmission unit 103 generates a downlink reference signal according to the control signals input from the control unit 102. The transmission unit 103 codes and modulates a HARQ indicator and downlink control information, and downlink data input from the higher layer processing unit 101. The transmission unit 103 multiplexes the PHICH, the PDCCH, the EPDCCH, the PDSCH, and the downlink reference signal, and outputs the signals to the terminal apparatus 200-1 through the transmit and receive antenna 105.

The coding portion 1031 codes the HARQ indicator, the downlink control information, and downlink data input from the higher layer processing unit 101, by using a coding scheme determined in advance, such as block coding, convolutional coding, or turbo coding. The coding portion 1031 performs coding by using a coding scheme which has been determined by the radio resource control portion 1011. The modulation portion 1032 modulates a coding bit input from the coding portion 1031 by a modulation scheme determined in advance, such as binary phase shift keying (BPSK), quadrature phase shift keying (QPSK), quadrature amplitude modulation (16AM), 64QAM, or 256QAM, or the modulation portion 1032 performs the modulation by using a modulation scheme determined by the radio resource control portion 1011.

The downlink-reference signal generation portion 1033 generates a sequence which is obtained by a rule determined in advance based on the physical cell identifier (PCI) or the like for identifying the base station apparatus 100-1 and is known to the terminal apparatus 2, as the downlink reference signal. The downlink-reference signal generation portion 1033 assigns the downlink-reference signal based on information regarding the sequence or assignment of the CSI-RS (NZP CSI-RS, ZP CSI-RS) input from the control unit 102.

The multiplexing portion 1034 multiplexes modulation symbols of each modulated channel, the generated downlink reference signal, and the generated downlink control information. That is, the multiplexing portion 1034 maps the modulation symbols of each modulated channel, the generated downlink reference signal, and the generated downlink control information on resource elements.

The radio transmission portion 1035 performs inverse fast Fourier transform (IFFT) on the multiplexed modulated symbols and the like, so as to generate OFDM symbols. The radio transmission portion 1035 appends a cyclic prefix (CP) to the OFDM symbol, generates a baseband digital signal, converts the baseband digital signal to an analog signal, and removes excessive frequency components by filtering. The radio transmission portion 1035 performs up-conversion into a carrier frequency, amplifies power, and outputs and transmits the power-amplified signal to the transmit and receive antenna 105.

The reception unit 104 separates, demodulates, and decodes reception signals received from the terminal apparatus 200-1 through the transmit and receive antenna 105, in accordance with control signals input from the control unit 102. The reception unit 104 outputs information obtained by the decoding, to the higher layer processing unit 101.

The radio reception portion 1041 converts the signals of an uplink received through the transmit and receive antenna 105 into a baseband signal by down-conversion. The radio reception portion 1041 removes unnecessary frequency components, controls an amplification level such that the signal levels are appropriately maintained, performs quadrature demodulation based on the in-phase components and quadrature components of the received signals, and converts the quadrature-demodulated analog signals to digital signals.

The radio reception portion 1041 removes a portion corresponding to a cyclic prefix (CP) from the converted digital signal. The radio reception portion 1041 performs fast Fourier transform (FFT) on the signal with the CP removed, extracts the signal of the frequency domain, and outputs the extracted signal to the demultiplexing portion 1042.

The demultiplexing portion 1042 separates the signal which has been input from the radio reception portion 1041, into a PDCCH, a PUSCH, an uplink reference signal, and the like. The separation is performed based on assignment information of radio resources, which is included in an uplink grant which is determined in advance by the radio resource control portion 1011 of the base station apparatus 100-1. The terminal apparatus 200-1 is notified of the assignment information. The demultiplexing portion 3055 compensates for the propagation path between the PUCCH and the PUSCH, from an estimation value of the propagation path input from the channel measurement portion 1045. The demultiplexing portion 1042 outputs the separated uplink reference signal to the channel measurement portion 1045.

The demodulation portion 1043 performs inverse discrete Fourier transform (IDFT) on the PUSCH and acquires modulation symbols. The demodulation portion 1043 demodulates a reception signal by using a modulation scheme determined in advance, such as BPSK, QPSK, 16QAM, 64QAM, or 256QAM, or by using a modulation scheme of which each terminal apparatus 2 is notified with an uplink grant in advance by the base station apparatus, for each of the modulation symbols of the PUCCH and the PUSCH.

The decoding portion 1044 decodes coding bits of the demodulated PUCCH and PUSCH at a coding rate. The coding rate is predetermined in predetermined coding scheme or a notification of the coding rate of the predetermined coding scheme is performed to the terminal apparatus 2 in advance by the base station apparatus, in the uplink grant. The decoding portion 1044 outputs the decoded uplink data and the decoded uplink control information to the higher layer processing unit 101. In a case where the PUSCH is retransmitted, the decoding portion 1044 performs decoding by using the coding bit which is held in a HARQ buffer and is input from the higher layer processing unit 101, and by using the demodulated coding bit.

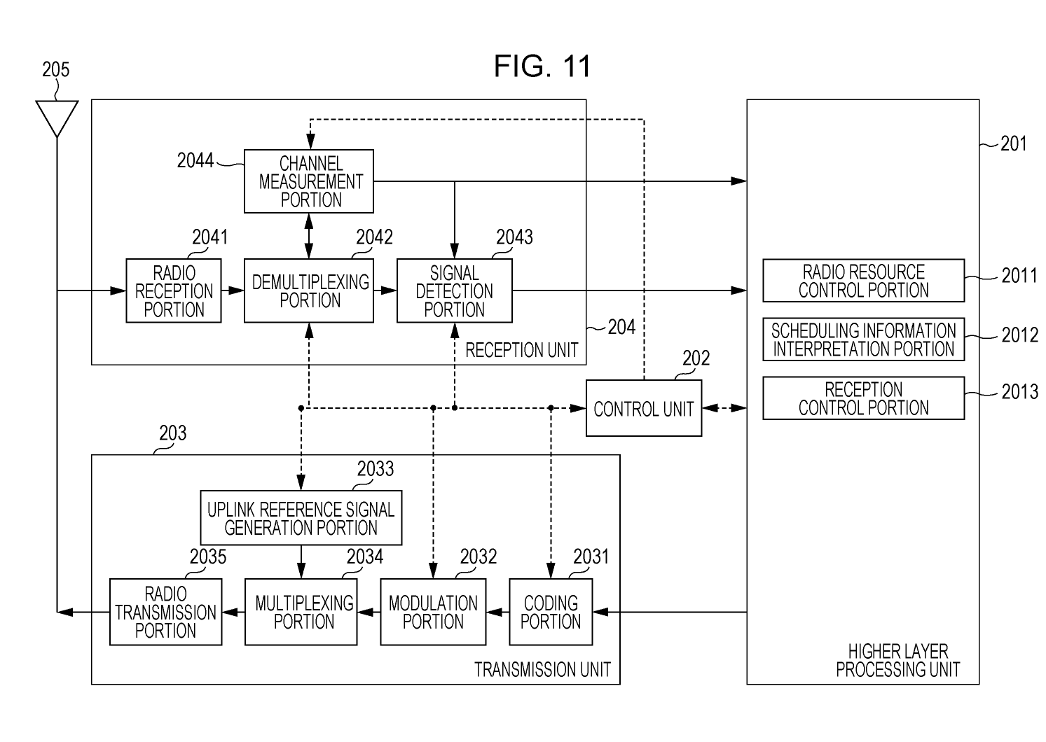

FIG. 11 is a schematic block diagram illustrating a structure of the terminal apparatus according to the embodiment. The base station apparatuses 200-1, 200-2, and 200-3 in the embodiment can include the advanced reception function. In the following descriptions, a case of the terminal apparatus 200-1 will be representatively described.

As illustrated in FIG. 11, the terminal apparatus 200-1 includes a higher layer processing unit 201, a control unit 202, a transmission unit 203, a reception unit 204, and a transmit and receive antenna 205. The higher layer processing unit 201 includes a radio resource control portion 2011, a scheduling information interpretation portion 2012, and a reception control portion 2013.

The transmission unit 203 includes a coding portion 2031, a modulation portion 2032, an uplink reference signal generation portion 2033, a multiplexing portion 2034, and a radio transmission portion 2035. The reception unit 204 includes a radio reception portion 2041, a demultiplexing portion 2042, a signal detection portion 2043, and a channel measurement portion 2044.

The higher layer processing unit 201 outputs uplink data (transport block) which has been generated by an operation and the like of a user, to the transmission unit 203. The higher layer processing unit 201 performs processing of a medium access control (MAC) layer, a packet data convergence protocol (PDCP) layer, a radio link control (RLC) layer, and a radio resource control (RRC) layer.

The radio resource control portion 2011 manages various types of setting information/parameters of the terminal apparatus. The radio resource control portion 2011 sets the various types of setting information/parameters based on a signal (for example, RRC Signaling, MAC CE) of the higher layer, which has been received from the base station apparatus 100-1. The radio resource control portion 2011 generates information assigned to each channel of an uplink, and outputs the generated information to the transmission unit 203.

The radio resource control portion 2011 can acquire information indicating a transmission mode configuration, from the reception unit 204. The radio resource control portion 2011 can acquire a channel state information report configuration from the reception unit 204. The radio resource control portion 2011 can acquire a CSI process from the reception unit 204. In a case where the radio resource control portion 2011 recognizes that the information regarding interference which is considered for calculating CSI is included, the radio resource control portion 2011 can extract the information regarding interference which is considered for calculating CSI, which is included in the CSI process, from the CSI process.

The radio resource control portion 2011 can acquire a channel state information report configuration from the reception unit 204. The radio resource control portion 2011 can acquire a channel state information request from the reception unit 204. The radio resource control portion 2011 can acquire information regarding application of the advanced reception function, from the reception unit 204.

The radio resource control portion 2011 can generate capability of the terminal apparatus, and output the generated capability to the transmission unit 203. The radio resource control portion 2011 can generate information indicating a transmission mode which can be configured by the terminal apparatus. The radio resource control portion 2011 can output the generated information to the transmission unit 203. The radio resource control portion 2011 can generate information indicating that a CSI-RS can be used, and can output the generated information to the transmission unit 203. The radio resource control portion 2011 can generate information indicating that the advanced reception function is provided, and can output the generated information to the transmission unit 203. The radio resource control portion 2011 can generate a channel state information report (CSI report), and output the generated CSI report to the transmission unit 203. The radio resource control portion 2011 can input the acquired information to the reception unit 204.

The scheduling information interpretation portion 2012 interprets downlink control information (DCI format, scheduling information) which has been received through the reception unit 204. The scheduling information interpretation portion 2012 generates control information for controlling the reception unit 204 and the transmission unit 203, based on a result obtained by interpreting the DCI format. The scheduling information interpretation portion 2012 outputs the generated control information to the control unit 202.

The reception control portion 2013 recognizes a subframe based on an RNTI used in scrambling a CRC parity bit which has been attached to the downlink control information. The reception control portion 2013 controls the reception unit 204 to decode a PDSCH based on the recognized subframe. Here, the function of the reception control portion 2013 may be included in the reception unit 204.

The control unit 202 generates control signals for controlling the reception unit 204 and the transmission unit 203 based on the information input from the higher layer processing unit 201. The control unit 202 outputs the generated control signals to the reception unit 204 and the transmission unit 203, so as to control the reception unit 204 and the transmission unit 203.

The control unit 202 can control the channel measurement portion 2044 to control information (reference signal sequence, type of CRS, or CSI-RS, and the like) regarding a reference signal used in channel estimation, or to control resource assignment thereof. The control unit 202 can control the channel measurement portion 2044 to control information (reference signal sequence, type of CRS, or CSI-RS, and the like) regarding a reference signal used for measuring interference, or to control resource assignment thereof.

The reception unit 204 separates, demodulates, and decodes a reception signal received from the base station apparatus 100-1 through the transmit and receive antenna 205, in accordance with a control signal input from the control unit 202. The reception unit 204 outputs the decoded information to the higher layer processing unit 201.

The radio reception portion 2041 converts the signals of a downlink received through the transmit and receive antenna 205 into a baseband signal by down-conversion. The radio reception portion 2041 removes unnecessary frequency components, controls an amplification level such that the signal levels are appropriately maintained, performs quadrature demodulation based on the in-phase components and quadrature components of the received signals, and converts the quadrature-demodulated analog signals to digital signals. The radio reception portion 2041 removes a portion corresponding to a cyclic prefix (CP) from the converted digital signal, performs fast Fourier transform (FFT) on the signal with the CP removed, and extracts the signal of the frequency domain.

The demultiplexing portion 2042 separates the extracted signal into a PHICH, a PDCCH, an EPDCCH, a PDSCH, a downlink-reference signal, and the like. The demultiplexing portion 2042 performs channel compensation on the PHICH, the PDCCH, and the EPDCCH, based on an estimation value of the propagation path input from the channel measurement portion 2044. The demultiplexing portion 2042 detects downlink control information, and outputs the detected downlink control information to the control unit 202. The control unit 202 outputs channel estimation values of the PDSCH and a desired signal to the signal detection portion 2043. The demultiplexing portion 2042 outputs the separated downlink-reference signal to the channel measurement portion 2044.

The channel measurement portion 2044 performs channel estimation used for demodulating a signal of the terminal apparatus, channel estimation for calculating CSI, interference measurement, and channel estimation of an interference signal. The channel estimation and the interference measurement can use the downlink-reference signal (CRS, DM-RS, CSI-RS, and the like).

The channel measurement portion 2044 outputs the channel estimation for calculating CSI, the interference measurement, and the channel estimation of an interference signal, to the higher layer processing unit 201. The channel measurement portion 2044 outputs the channel estimation used for demodulating a signal of the terminal apparatus, and a channel estimation value/interference measurement value of the interference signal, to the signal detection portion 2043.

The signal detection portion 2043 detects downlink data (transport block) of a terminal apparatus which is connected to the base station apparatus, based on the PDSCH, the channel estimation value, information regarding application of the advanced reception function/information necessary for removing or suppressing an interference signal. The signal detection portion 2043 outputs the detected downlink data to the higher layer processing unit 201. In a case where information indicating a message of applying the advanced reception function is acquired, the signal detection portion 2043 removes or suppresses an interference signal by using the advanced reception function. As a method of removing or suppressing the interference signal, linear detection, maximum likelihood estimation, an interference canceller, and the like are provided. Examples of the linear detection include linear minimum mean square error-interference rejection combining (LMMSE-IRC), Enhanced LMMSE-IRC, and widely linear MMSE-IRC (WLMMSE-IRC). Examples of the maximum likelihood estimation include maximum likelihood (ML), reduced complexity ML (R-ML), iterative ML, and iterative R-ML. Examples of the interference canceller include turbo successive interference cancellation (SIC), parallel interference cancellation (PIC), linear code word level SIC (L-CWIC), ML code word level SIC (ML-CWIC), and symbol level IC (SLIC).

For example, the signal detection portion 2043 which includes the interference canceller performs maximum likelihood demodulation/maximum likelihood decoding of a signal from another base station apparatus. The maximum likelihood demodulation/maximum likelihood decoding is performed by using a modulation scheme, an MCS, the number of spatial multiplexing, and the like for the signal from the other base station apparatus, which is included in information necessary for removing or suppressing an interference signal. The signal detection portion 2043 generates a replica signal of the signal from the other base station apparatus, by using a flexible determination value which corresponds to a result of the maximum likelihood demodulation/maximum likelihood decoding. The signal detection portion 2043 subtracts the replica signal from a signal which is input from the demultiplexing portion 2042, so as to suppress interference. The signal detection portion 2043 demodulates/decodes a signal obtained by subtracting the interference. Thus, it is possible to demodulate/decode a desired signal from the base station apparatus with high accuracy.

The transmission unit 203 generates an uplink reference signal according to the control signals input from the control unit 202. The transmission unit 203 codes and modulates uplink data (transport block) input from the higher layer processing unit 201. The transmission unit 203 multiplexes the PUCCH, the PUSCH, and the generated uplink reference signal, and outputs a result of the multiplexing to the base station apparatus 100-1 through the transmit and receive antenna 205.

The coding portion 2031 performs coding such as convolutional coding and block coding, on uplink control information input from the higher layer processing unit 201. The coding portion 2031 performs turbo coding based on information which is used in scheduling a PUSCH.

The modulation portion 2032 modulates coding bits input from the coding portion 2031, by using a modulation scheme such as BPSK, QPSK, 16QAM, and 64QAM. The modulation scheme is determined by using a notification of downlink control information, or is predetermined for each channel.

The uplink reference signal generation portion 2033 generates a sequence obtained by a predetermined rule (expression), based on a physical cell identifier (referred to as a physical cell identity: PCI, Cell ID, and the like) for identifying the base station apparatus 100-1, a bandwidth for mapping an uplink reference signal, a cyclic prefix of which a notification is performed by using an uplink grant, a value of a parameter for generating a DMRS sequence, and the like.

The multiplexing portion 2034 arranges modulation symbols of a PUSCH and performs discrete Fourier transform (DFT), in accordance with a control signal input from the control unit 202. The multiplexing portion 2034 multiplexes signals of a PUCCH and a PUSCH, and the generated uplink reference signal for each transmit antenna port. That is, the multiplexing portion 2034 maps the signals of a PUCCH and a PUSCH, and the generated uplink reference signal on resource elements for each transmit antenna port.

The radio transmission portion 2035 performs inverse fast Fourier transform (IFFT) on the multiplexed signals. The radio transmission portion 2035 performs modulation by using a SC-FDMA scheme, so as to generate SC-FDMA symbols. The radio transmission portion 2035 appends a CP to the SC-FDMA symbol, generates a baseband digital signal, and converts the baseband digital signal to an analog signal. The radio transmission portion 2035 removes excessive frequency components. The radio transmission portion 2035 performs conversion into a carrier frequency by up-conversion, amplifies power, and outputs and transmits the power-amplified signal to the transmit and receive antenna 205.

As described above, the base station apparatus transmits information regarding an interference which is considered for calculating CSI, to the terminal apparatus. Thus, it is possible to realize efficient data transmission also considering reception capacity of the terminal apparatus, in a wireless environment having various interferences.

In the interference information described in the embodiment, the terminal apparatus does not need to recognize that the interference information is information for an interference signal. That is, the interference information is information used when the terminal apparatus measures, generates, and reports CSI, and simply may be used as information or information for CSI.

A program operated in the base station apparatus and a mobile station apparatus according to the embodiment is a program (a program for causing a computer to function) to control a CPU and the like so as to realize the functions of the above embodiment of the present invention. Information which is handled by the apparatuses is temporarily accumulated in a RAM while processed, and is then stored in various ROMs or an HDD. Information is read by the CPU as necessary, and is modified and written. As a recording medium for storing the program, any of a semiconductor medium (for example, ROM, non-volatile memory card, and the like), an optical recording medium (for example, DVD, MO, MD, CD, BD, and the like), a magnetic recording medium (for example, magnetic type, flexible disc, and the like) may be used. The downloaded program is executed, and thus the functions of the above-described embodiment are realized, and processing is performed along with an operating system, another application program, and the like, based on an instruction of the program, and thus the functions of the present invention may be realized.

In a case where the program is distributed into the market, distribution can be performed by storing the program in a portable recording medium, or by transmitting the program to a server computer which is connected through a network such as the Internet. In this case, a storage apparatus such as the server computer is also included in the present invention. Part or all of the mobile station apparatus and the base station apparatus in the above-described embodiment may be typically implemented as an LSI, which is an integrated circuit. The functional blocks of the reception apparatus may be individually integrated into chips, or some or all of the functional blocks may be integrated into a chip. In a case where each of the functional blocks is integrated into a circuit, an integrated circuit control unit for controlling the integrated circuit is added.

The integration into a circuit is not limited to LSI and may be implemented by a dedicated circuit or a general-purpose processor. In a case where a technique for integration into a circuit, which will replace LSI, emerges with the advancement of the semiconductor technology, an integrated circuit based on the technique may be used.

This application invention is not limited to the above-described embodiment. The terminal apparatus in this application invention is not limited to application to a mobile station apparatus, and may be applied to stationary or immovable electronic apparatuses indoors and outdoors, for example, such as an AV system, kitchen equipment, cleaning and washing equipment, air conditioning equipment, office equipment, vending machine, and other living appliances.

While the embodiments of the invention have been described referring to the drawings, specific configurations are not limited to the embodiments and design changes within the scope of the invention are also encompassed.

### INDUSTRIAL APPLICABILITY

The present invention is appropriately used in a base station apparatus and a transmission method in a communication system.

This application is based upon and claims the benefit of priority of the prior Japanese Patent Application No. 2014-092347, filed on Apr. 28, 2014, the entire contents of which are incorporated herein by reference.

### REFERENCE SIGNS LIST

100-1, 100-2, 100-3 BASE STATION APPARATUS

200-1, 200-2, 200-3 TERMINAL APPARATUS

101 HIGHER LAYER PROCESSING UNIT

102 CONTROL UNIT

103 TRANSMISSION UNIT

104 RECEPTION UNIT

105 TRANSMIT AND RECEIVE ANTENNA

1011 RADIO RESOURCE CONTROL PORTION

1012 SCHEDULING PORTION

1013 TRANSMISSION CONTROL PORTION

1031 CODING PORTION

1032 MODULATION PORTION

1033 DOWNLINK-REFERENCE SIGNAL GENERATION PORTION

1034 MULTIPLEXING PORTION

1035 RADIO TRANSMISSION PORTION

1041 RADIO RECEPTION PORTION

1042 DEMULTIPLEXING PORTION

1043 DEMODULATION PORTION

1044 DECODING PORTION

1045 CHANNEL MEASUREMENT PORTION

201 HIGHER LAYER PROCESSING UNIT

202 CONTROL UNIT

203 TRANSMISSION UNIT

204 RECEPTION UNIT

205 TRANSMIT AND RECEIVE ANTENNA

2011 RADIO RESOURCE CONTROL PORTION

2012 SCHEDULING INFORMATION INTERPRETATION PORTION

2013 RECEPTION CONTROL PORTION

2031 CODING PORTION

2032 MODULATION PORTION

2033 UPLINK REFERENCE SIGNAL GENERATION PORTION

2034 MULTIPLEXING PORTION

2035 RADIO TRANSMISSION PORTION

2041 RADIO RECEPTION PORTION

2042 DEMULTIPLEXING PORTION

2043 SIGNAL DETECTION PORTION

2044 CHANNEL MEASUREMENT PORTION

1. A base station apparatus which communicates with a terminal apparatus, the base station apparatus comprising:
a higher layer processing unit that configures at least one channel state information process which is a configuration relating to a report of channel state information and
a reception unit that receives the channel state information which is reported based on the channel state information process, wherein
each channel state information process includes information regarding a channel-state-information estimation reference signal, information regarding a channel-state-information estimation interference measurement resource, and information regarding an interference which is considered for calculating the channel state information.

2. The station apparatus according to claim 1, wherein
the higher layer processing unit configures a transmission mode of a downlink, which corresponds to information indicating a transmission method for transmitting user data of a downlink, and
in a case where the transmission mode is a predetermined transmission mode, the higher layer processing unit configures information regarding an interference which is considered for calculating the channel state information.

3. The station apparatus according to claim 2, wherein
the transmission mode of a downlink includes at least a transmission mode in which the information regarding the channel-state-information estimation reference signal and the information regarding the channel-state-information estimation interference measurement resource are allowed to be configured, and
in a case where the higher layer processing unit configures the transmission mode in which the information regarding the channel-state-information estimation interference measurement resource is allowed to be configured, the higher layer processing unit configures the information regarding an interference which is considered for calculating the channel state information.

4. The station apparatus according to claim 1, wherein
the higher layer processing unit configures information regarding a feedback procedure of the channel state information, and
in a case where the information regarding a feedback procedure of the channel state information corresponds to a predetermined mode, the higher layer processing unit configures the information regarding an interference which is considered for calculating the channel state information.

5. The station apparatus according to claim 1, wherein
the higher layer processing unit configures information regarding a type of feedback of the channel state information, and
in a case where the information regarding a feedback type of the channel state information corresponds to a predetermined mode, the higher layer processing unit configures the information regarding an interference which is considered for calculating the channel state information.

6. The station apparatus according to claim 1, wherein
the report of the channel state information includes a rank indicator for designating an appropriate number of spatial multiplexing, a precoding matrix indicator for designating a suitable precoder, and a channel quality indicator CQI for designating an appropriate transmission rate and
in a case where the higher layer processing unit configures the rank indicator, the higher layer processing unit configures the information regarding an interference which is considered for calculating the channel state information.

7. The station apparatus according to claim 1, wherein
the information regarding an interference which is considered for calculating the channel state information includes a cell identifier of a cell to which a terminal apparatus other than the terminal apparatus is connected.

8. The station apparatus according to claim 1, wherein
the information regarding an interference which is considered for calculating the channel state information includes transmission power which is transmitted by a terminal apparatus other than the terminal apparatus.

9. The station apparatus according to claim 1, wherein
the information regarding an interference which is considered for calculating the channel state information includes information for specifying a resource to which a reference signal for reception state information of a terminal apparatus other than the terminal apparatus is assigned.

10. A transmission method of a base station apparatus which communicates with a terminal apparatus, the method comprising:
a step of configuring at least one channel state information process which is a configuration relating to a report of channel state information and
a step of receiving the channel state information which is reported based on the channel state information process, wherein
each channel state information process includes information regarding a channel-state-information estimation reference signal, information regarding a channel-state-information estimation interference measurement resource, and information regarding an interference which is considered for calculating the channel state information.
